(19) United States
(12) Patent Application Publication
(10) Pub. No.: US 2024/0367604 A1
(43) Pub. Date: Nov. 7, 2024

(54) VEHICLE INTERIOR COMPONENT

(71) Applicant: Yanfeng International Automotive Technology Co., Ltd., Novi, MI (US)

(72) Inventor: Holger Maul, Groß-Zimmern (DE)

(21) Appl. No.: 18/772,443

(22) Filed: Jul. 15, 2024

Related U.S. Application Data
(63) Continuation of application No. PCT/US2023/011070, filed on Jan. 18, 2023.
(60) Provisional application No. 63/300,836, filed on Jan. 19, 2022.

(51) Int. Cl. B60R 21/015; B60R 21/0136; B60R 21/2338

(52) U.S. Cl. CPC B60R 21/01554; B60R 21/0136; B60R 21/2338

(57) ABSTRACT

A vehicle interior component may comprise an airbag and a retaining mechanism to retain a retaining member for standard airbag deployment and to release the retaining member for extended airbag deployment. In standard deployment, the airbag may be inflated in a standard form; in extended deployment the airbag may be inflated in an extended form/shape. The component may comprise a member/tether arrangement within the airbag and coupled to the retaining member for standard deployment. The member may comprise a section to retain the airbag for standard deployment, a section to release for extended deployment, and a connection for the retaining member. The retaining member may comprise a strap, rope, loop, etc. The retaining mechanism may comprise a pin to retain an aperture of the retaining member. The pin may retract to release the retaining member for extended airbag deployment in one or multiple forms.

### CROSS-REFERENCE TO RELATED APPLICATIONS

The present application is a continuation of PCT/International Patent Application No. PCT/US2023/011070 titled “COMPONENT FOR VEHICLE INTERIOR” filed Jan. 18, 2023, which claims the benefit of U.S. Provisional Patent Application No. 63/300,836 titled “VEHICLE INTERIOR COMPONENT” filed Jan. 19, 2022.

The present application claims priority to and incorporates by reference in full the following patent applications: (1) U.S. Provisional Patent Application No. 63/300,836 titled “VEHICLE INTERIOR COMPONENT” filed Jan. 19, 2022; (2) PCT/International Patent Application No. PCT/US2023/011070 titled “COMPONENT FOR VEHICLE INTERIOR” filed Jan. 18, 2023.

### FIELD

The present invention relates to a component for a vehicle interior.

The present invention also relates to component for a vehicle interior configured to facilitate deployment of an airbag.

### BACKGROUND

It is known to provide a component for a vehicle interior configured for deployment of an airbag.

It would be advantageous to provide an improved component for a vehicle interior configured for deployment of an airbag.

It would also be advantageous to provide an improved component for a vehicle interior configured for deployment of an airbag in a standard form and in an extended form.

It would also be advantageous to provide an improved component for a vehicle interior configured for deployment of an airbag in a standard deployment comprising a standard form and in an extended deployment comprising an extended form.

It would also be advantageous to provide an improved component for a vehicle interior configured for deployment of an airbag in a standard deployment comprising a standard form and in an extended deployment comprising an extended form based on position of seat for an occupant and/or position of an occupant in the vehicle interior.

It would also be advantageous to provide an improved airbag system configured for deployment of an airbag in a standard deployment and in an extended deployment based a signal representative of position of an occupant/seat in the vehicle interior.

### SUMMARY

The present invention relates to a component for an interior of a vehicle configured for deployment of an airbag for an occupant in a seat of the vehicle upon an event comprising (a) an airbag configured to be inflated for deployment, (b) a retaining mechanism, and (c) a retaining member configured to be retained by the retaining mechanism for standard deployment of the airbag and to be released by the retaining mechanism for extended deployment of the airbag. In standard deployment the airbag may be inflated in a standard form. In extended deployment the airbag may be inflated in an extended form. The component may comprise a member for the airbag. The member may comprise a tether coupled to the retaining member. The member for the airbag may comprise a standard deployment section and an extended deployment section; the retaining member may be coupled to the member; so that (1) the extended deployment section is retained by the retaining member and the standard deployment section is deployed for standard deployment and (2) the extended deployment section is released by the retaining member and the standard deployment section and the extended deployment section are deployed for extended deployment. The member for the airbag may comprise a connection section between the standard deployment section and the extended deployment section; the retaining member may be connected to the connection section. The retaining member may comprise at least one of (a) a strap, (b) a rope, (c) a flexible member and/or (d) a loop. The retaining mechanism may comprise a pin; the retaining member may comprise an aperture configured to be retained by the pin. The retaining mechanism may comprise an actuator actuated by a control system and a retaining pin configured to be actuated by the actuator. The retaining member may comprise an aperture configured for engagement with the retaining pin; the aperture may be engaged with the retaining pin for standard deployment; the aperture may be disengaged from the retaining pin for extended deployment. The retaining member may comprise a set of retaining members; the extended form may comprise a first extended form with one retaining member released and one retaining member retained. The first extended form may comprise an asymmetrical form. The asymmetrical form may comprise an inclined surface facing the occupant. The retaining member may comprise a set of retaining members; the extended form may comprise a second extended form with all retaining members released; the second extended form may comprise a generally symmetrical form. The symmetrical form may comprise a parallel surface facing the occupant. The retaining member may comprise a set of retaining members; one retaining member may comprise a first length and one retaining member may comprise a second length longer than the first length. The component may comprise a member for the airbag configured to provide for standard deployment of the airbag; the set of retaining members may be attached to the member for the airbag so that one retaining member is at a first position along the member and one retaining member is at a second position along the member; the first position may be different from the second position. The first position and the second position may comprise an asymmetrical attachment of the retaining member.

The present invention relates to a method of operation of an airbag system configured for deployment of an airbag into an interior of a vehicle comprising an occupant in a seat comprising the steps of (a) monitoring the operation of the vehicle for an event, (b) monitoring position of the occupant and/or seat in the interior of the vehicle, and (c) deploying the airbag upon detection of an event (1) in a standard form if the occupant and/or seat is in a standard position or (2) in an extended form if the occupant and/or seat is beyond the standard position. The airbag system may comprise a member for the airbag coupled to a retaining member for the airbag. The retaining member may be configured to retain the airbag for standard deployment. The member for the airbag may comprise a standard deployment section and an extended deployment section; the retaining member for the airbag may be coupled to the member and to a retaining mechanism; the step of deploying the airbag may comprise retaining the retaining member at the retaining mechanism for standard deployment and releasing the retaining member from the retaining mechanism the airbag for extended deployment. The step of deploying the airbag in the extended form may comprise disconnecting the retaining member intact from the retaining mechanism.

The present invention relates to a component for an interior of a vehicle configured for deployment of an airbag for an occupant in a seat of the vehicle upon an event comprising (a) an airbag configured to be inflated for deployment; (b) a retaining mechanism; and (c) a retaining member configured to be retained by the retaining mechanism for standard deployment of the airbag and to be released by the retaining mechanism for extended deployment of the airbag. In standard deployment the airbag may be inflated in a standard form. In extended deployment the airbag may be inflated in an extended form. The retaining member may comprise a flexible member. The component may comprise a member for the airbag. The member for the airbag may be configured to provide for standard deployment of the airbag. The member for the airbag may comprise a tether arrangement. The member may comprise a tether coupled to the retaining member. The member for the airbag may comprise a flexible web material. The member for the airbag may comprise (1) a section configured to retain the airbag for standard deployment and (2) a section configured to release for extended deployment. The member for the airbag may comprise a connection to the retaining member. The member for the airbag may comprise (1) a section configured to retain the airbag for standard deployment and (2) a section configured to release for extended deployment and (3) a connection for the retaining member. The member for the airbag may comprise a fabric material. The member for the airbag may comprise a standard deployment section and an extended deployment section. The standard deployment section may be deployed for standard deployment. The standard deployment section and the extended deployment section are deployed for extended deployment. The member for the airbag may comprise a standard deployment section and an extended deployment section. The retaining member may be coupled to the member so that (1) the extended deployment section may be retained by the retaining member and the standard deployment section is deployed for standard deployment and (2) the extended deployment section may be released by the retaining member and the standard deployment section and the extended deployment section are deployed for extended deployment. The member for the airbag may comprise a connection section between the standard deployment section and the extended deployment section; the retaining member may be connected to the connection section. The member for the airbag may be within the airbag. The member for the airbag may be coupled to the retaining member for standard deployment. The member for the airbag may be uncoupled from the retaining member for extended deployment. The extended form may be larger than the standard form. In the extended form the airbag may extend further than in the standard form. The component may comprise an airbag system comprising an airbag module comprising the airbag. The airbag system may comprise the inflator and the retaining member. The airbag system may comprise a member for the airbag coupled to the retaining member and configured to retain the airbag for standard deployment. The component may comprise an inflator configured to inflate the airbag for deployment. The component may comprise an airbag system comprising the airbag and a control system. The control system may be configured to be operated by a signal from a vehicle system. The control system may be configured to be operated by a signal from a vehicle system representative of position of the seat for the occupant. The control system may be configured to be operated by a signal from a vehicle system representative of position of the occupant. The control system may be configured to be operated by a signal from a sensor or detector within the vehicle interior. The control system may be configured to be operated by a signal representative of the position of the seat for the occupant. The control system may be configured to be operated by a signal representative of the position of the occupant. The control system may be configured to be operated by a signal from a camera. The control system may be configured to actuate the retaining mechanism for extended deployment of the airbag. The component may comprise a control system configured to actuate the inflator and to operate the retaining mechanism for extended deployment of the airbag. The control system may comprise an electronic control unit. The control system may be configured to actuate the inflator based on a deployment signal indicating the event. The event may comprise detection of a change in acceleration of the vehicle. The event may comprise detection of a rapid deceleration of the vehicle. The event may comprise detection of an accident involving the vehicle. The control system may be configured to actuate the retaining mechanism to facilitate extended deployment based upon a signal. The signal may comprise a signal indicating position of the occupant. The signal may comprise a signal indicating position of the seat with the occupant. The signal may comprise a signal from a sensor. The signal may comprise a signal indicating the position of a seat or an occupant at a distance beyond a threshold distance. If the distance is within the threshold distance the retaining mechanism may be configured to retain for standard deployment; if the distance is greater than the threshold distance the retaining mechanism may be configured to release for extended deployment. The retaining mechanism may be configured to retain the retaining member for standard deployment and to release the retaining member for extended deployment. The retaining member may comprise a strap. The retaining member may comprise a rope. The retaining member may comprise a flexible member. The retaining member may comprise a loop. The retaining mechanism may comprise a pin; the retaining member may comprise an aperture configured to be retained by the pin. The retaining mechanism may be configured to retract the pin to release the retaining member for extended deployment of the airbag. The retaining member may be configured to be retained by the pin of the retaining mechanism for standard deployment and to be released by the pin of the retaining mechanism for extended deployment. The retaining mechanism may comprise an actuator actuated by the control system. The retaining mechanism may comprise a retaining pin configured to be actuated by the actuator. The retaining mechanism may be configured to retain the retaining member on the retaining pin for standard deployment. The retaining mechanism may be configured to release the retaining member at the retaining pin for extended deployment. The retaining pin may be configured to be retracted for extended deployment. The retaining pin may be configured to be extended for standard deployment and to be retracted for extended deployment. The retaining member may comprise an aperture configured for engagement with the retaining pin. The aperture may be engaged with the retaining pin for standard deployment. The aperture may be disengaged from the retaining pin for extended deployment. The component may comprise a trim panel configured to provide an airbag door formed at deployment of the airbag. The trim panel may comprise an instrument panel. The airbag may be configured to deploy from the instrument panel. The trim panel may be provided on a steering wheel. The airbag may be configured to deploy from a steering wheel. The airbag may be configured to deploy from a trim panel. The retaining member may comprise a set of retaining members. The extended form may comprise a first extended form with one retaining member released and one retaining member retained. The first extended form may comprise an asymmetrical form. The asymmetrical form may comprise an inclined surface facing the occupant. The extended form may comprise a second extended form with all retaining members released. The second extended form may comprise a generally symmetrical form. The symmetrical form may comprise a parallel surface facing the occupant. The airbag may be actuated by a control system configured to actuate the airbag in a first extended deployment with one retaining member retained and a second extended deployment with all retaining members released. The retaining member may comprise a set of retaining members; one retaining member may comprise a first length and one retaining member may comprise a second length longer than the first length. The set of retaining members may be attached asymmetrically so that the extended form may comprise an asymmetrical form. The component may comprise a member for the airbag configured to provide for standard deployment of the airbag; the set of retaining members may be attached to the member for the airbag so that one retaining member is at a first position along the member and one retaining member is at a second position along the member; the first position may be different from the second position. The first position and the second position may comprise an asymmetrical attachment of the retaining member. The component may comprise a control system; the retaining mechanism may comprise a set of pins; the retaining member may comprise an aperture configured to be retained by the set of pins; the control system may be configured to actuate the retaining mechanism by releasing at least one pin of the set of pins.

The present invention relates to an airbag system for a vehicle interior component for an interior of a vehicle configured for deployment of an airbag for an occupant in a seat of the vehicle upon an event comprising (a) an airbag configured for deployment in standard deployment or extended deployment; (b) an inflator configured to inflate the airbag for deployment; (c) a retainer configured to retain for standard deployment and to release for extended deployment; and (d) a control system configured to actuate the inflator and to operate the retainer. The control system may be configured to actuate the retainer for extended deployment of the airbag. The airbag may comprise a member. In standard deployment the airbag may be inflated in a standard form. In extended deployment the airbag may be inflated in an extended form. The airbag may comprise a front shell and a rear shell. The retainer may be configured to retain the rear shell of the airbag at least partially for standard deployment and to release the rear shell of the airbag fully for extended deployment. The member may comprise a tether arrangement comprising a web of material. The tether arrangement may comprise a flexible tether. The retainer may comprise a fastening member coupled to the flexible tether. The retainer comprise a retaining member coupled to the flexible tether. The system may comprise a retaining mechanism comprising the retainer; the retainer may comprise a retaining member configured to be retained by the retaining mechanism for standard deployment and to be released by the retaining mechanism for extended deployment. The system may comprise a retaining member configured to retain the airbag at a connection to the member for standard deployment and to release the airbag at a connection to the retaining mechanism for extended deployment. The system may comprise a retaining member configured to retain the airbag at a connection to the member and at a connection to the retaining mechanism for standard deployment and to release the airbag at the connection to the retaining mechanism for extended deployment. The retaining member may comprise a flexible member. The member may comprise (a) a standard deployment section and an extended deployment section and (b) a retaining member coupled to the member and configured to be actuated with the retainer to retain the airbag for standard deployment and to release the airbag for extended deployment. The flexible member for the airbag may comprise a connection section; the retainer may comprise a retaining member connected to the connection section of the member for the airbag. The standard deployment section of the member may be released for standard deployment so that the airbag is deployed in standard form. The extended deployment section of the member may be released for extended deployment so that the airbag is deployed in extended form. The retainer may be configured to retain the extended deployment section of the member for standard deployment and to release the extended deployment section of the member for extended deployment. The system may be configured to be operated according to a method comprising the steps of (a) monitoring the operation of the vehicle for the event; (b) monitoring position of the occupant and/or seat in the interior of the vehicle; (c) deploying the airbag upon detection of the event (1) in the standard form if the occupant and/or seat is in detected in a standard position or (2) in the extended form if the occupant and/or seat is detected to be beyond the standard position.

The present invention relates to a method of operation of an airbag system configured for deployment of an airbag into an interior of a vehicle comprising an occupant in a seat comprising the steps of: (a) monitoring the operation of the vehicle for an event; (b) monitoring position of the occupant and/or seat in the interior of the vehicle; and (c) deploying the airbag upon detection of an event (1) in a standard form if the occupant and/or seat is in a standard position or (2) in an extended form if the occupant and/or seat is beyond the standard position. The airbag may be deployed in standard deployment for standard form and in extended deployment for extended form; the extended form may be larger than standard form. The airbag system may comprise a retaining mechanism actuated by the control system and a retaining member configured to be retained by the retaining mechanism for standard deployment and to be released by the retaining mechanism for extended deployment. The airbag system may comprise a member for the airbag coupled to a retaining member for the airbag; the retaining member may be configured to retain the airbag for standard deployment. The member for the airbag may comprise a standard deployment section and an extended deployment section; the retaining member for the airbag may be coupled to the member and to a retaining mechanism; the step of deploying the airbag may comprise retaining the retaining member at the retaining mechanism for standard deployment and releasing the retaining member from the retaining mechanism the airbag for extended deployment. The step of deploying the airbag may comprise retaining the retaining member at the retaining mechanism and to the member for the airbag for standard deployment and releasing the retaining member from the retaining mechanism the airbag for extended deployment. The step of deploying the airbag in the standard form may comprise retaining the member for the airbag by the retaining member. The step of deploying the airbag in the extended form may comprise disconnecting the retaining member from the retaining mechanism. The step of deploying the airbag in the extended form may comprise disconnecting the retaining member from the retaining mechanism without severing the retaining member. The step of deploying the airbag in the extended form may comprise disconnecting the retaining member intact from the retaining mechanism. The retaining member may comprise a loop; the step of deploying the airbag in the extended form may comprise disconnecting the loop of the retaining member from the retaining mechanism. The member may comprise a tether comprising a web of material. The airbag system may comprise the airbag and a control system. The control system may be configured to be operated by a signal from a vehicle system representative of the event. The control system may be configured to be operated by a signal representative of the position of the seat for the occupant. The control system may be configured to be operated by a signal representative of the position of the occupant. The airbag may be configured to deploy from a steering wheel; the control system may be configured to be operated by a signal representative of the position of the seat for the occupant relative to the steering wheel. The airbag may be configured to deploy from an instrument panel; the control system may be configured to be operated by a signal representative of the position of the seat for the occupant relative to the instrument panel.

The present invention relates to a component for an interior of a vehicle configured for deployment of an airbag for an occupant in a seat of the vehicle upon an event comprising (a) an airbag configured for deployment in standard deployment or in extended deployment; (b) an inflator configured to inflate the airbag for deployment; (c) a retainer configured to retain for standard deployment and to release for extended deployment; and (d) a control system configured to actuate the inflator and to operate the retainer. The control system may be configured to actuate the retainer for extended deployment of the airbag. In standard deployment the airbag may be inflated in a standard form. In extended deployment the airbag may be inflated in an extended form. The extended form may be larger in size than the standard form. In the extended form the airbag may extend further toward the occupant than in the standard form. In the extended form the airbag may deploy further from the inflator toward the occupant than in the standard form. The control system may comprise an electronic control unit. The control system may be configured to actuate the inflator based on a deployment signal indicating the event. The deployment signal may comprise a signal indicating the position of the occupant and/or the seat for the occupant at a distance beyond a threshold distance. If the distance is within the threshold distance the retainer may be configured to retain for standard deployment; if the distance is greater than the threshold distance the retainer may be configured to release for extended deployment. The retainer may comprise a retaining member configured to retain the airbag for standard deployment and to release the airbag for extended deployment. The retaining member may comprise a strap. The retaining member may comprise a rope. The retaining member may comprise a flexible member. The component may comprise a retaining mechanism comprising the retainer; the retaining member may be configured to be retained by the retaining mechanism for standard deployment and to be released by the retaining mechanism for extended deployment. The retaining mechanism may comprise an actuator actuated by the control system. The component may comprise a member for the airbag configured to provide for standard deployment and for extended deployment. The member may comprise a tether. The member may comprise a tether comprising a dual web of material. The material may comprise a fabric. The member for the airbag may comprise a standard deployment section and an extended deployment section; the member may be configured to be actuated with the retainer to retain the airbag for standard deployment with the standard deployment section and to release the airbag for extended deployment with the standard deployment section and the extended deployment section. The member for the airbag may comprise a connection section; the retaining member may be connected to the connection section of the member for the airbag. The standard deployment section of the member may be released for standard deployment. The extended deployment section of the member may be released for extended deployment. The standard deployment section of the member may be released for standard deployment so that the airbag is deployed in standard form. The extended deployment section of the member may be released for extended deployment so that the airbag is deployed in extended form. The retainer may be configured to retain the extended deployment section of the member for standard deployment and to release the extended deployment section of the member for extended deployment. The member for the airbag may be within the airbag. The member for the airbag may be coupled to the retainer for standard deployment. The member for the airbag may be uncoupled from the retainer for extended deployment.

### FIGURES

FIG. 1A is a schematic perspective view of a vehicle according to an exemplary embodiment.

FIG. 1B is schematic partial perspective view of a vehicle interior according to an exemplary embodiment.

FIGS. 2A and 2B are schematical perspective views of a vehicle interior according to an exemplary embodiment.

FIGS. 3A and 3B are schematical perspective views of a vehicle interior according to an exemplary embodiment.

FIGS. 4A and 4B are schematical perspective views of a vehicle interior according to an exemplary embodiment.

FIG. 5 is a schematic perspective view of a component for a vehicle interior shown as an instrument panel with a steering wheel according to an exemplary embodiment.

FIGS. 6A through 6D are schematic perspective views of a component for a vehicle interior shown as an instrument panel with an airbag system according to an exemplary embodiment.

FIGS. 7A through 7C are schematic perspective views of a component for a vehicle interior shown as a steering wheel with an airbag system according to an exemplary embodiment.

FIGS. 8A through 8E are schematic side elevation views of a component for a vehicle interior shown as a steering wheel with an airbag system according to an exemplary embodiment.

FIGS. 9A through 9G are schematic side elevation views of a component for a vehicle interior shown as a steering wheel with an airbag system according to an exemplary embodiment.

FIGS. 10A through 10C are schematic side elevation views of a vehicle interior with a component shown as a steering wheel with an airbag system for deployment of an airbag according to an exemplary embodiment.

FIGS. 11A through 11C are schematic top plan views of a vehicle interior with a component shown as a steering wheel with an airbag system for deployment of an airbag according to an exemplary embodiment.

FIGS. 12A through 12D are schematic side elevation views of a vehicle interior with a component shown as a steering wheel with an airbag system for deployment of an airbag according to an exemplary embodiment.

FIGS. 13A through 13D are schematic top plan views of a vehicle interior with a component shown as a steering wheel with an airbag system for deployment of an airbag according to an exemplary embodiment.

FIGS. 14A through 14C are schematic side elevation views of a vehicle interior with a component shown as a steering wheel with an airbag system for deployment of an airbag according to an exemplary embodiment.

FIGS. 15A through 15C are schematic side elevation views of a vehicle interior with a component shown as a steering wheel with an airbag system for deployment of an airbag according to an exemplary embodiment.

FIGS. 16A through 16C are schematic side elevation views of a vehicle interior with a component shown as a steering wheel with an airbag system for deployment of an airbag according to an exemplary embodiment.

FIGS. 17A through 17C are schematic side elevation views of a vehicle interior with a component shown as an instrument panel with an airbag system for deployment of an airbag according to an exemplary embodiment.

FIGS. 18A through 18D are schematic side elevation views of a vehicle interior with a component shown as an instrument panel with an airbag system for deployment of an airbag according to an exemplary embodiment.

FIGS. 19A and 19B are schematic perspective views of a component shown as a steering wheel with an airbag system for standard deployment according to an exemplary embodiment.

FIGS. 20A and 20B are schematic perspective views of a component shown as a steering wheel with an airbag system for extended deployment according to an exemplary embodiment.

FIGS. 21A and 21B are schematic perspective views of a component shown as a steering wheel with an airbag system for standard deployment according to an exemplary embodiment.

FIGS. 21C through 21E are schematic perspective views of a component shown as a steering wheel with an airbag system for extended deployment according to an exemplary embodiment.

FIG. 22A is a schematic perspective view of a component shown as a steering wheel with an airbag system according to an exemplary embodiment.

FIG. 22B is a schematic exploded perspective view of a component shown as a steering wheel with an airbag system according to an exemplary embodiment.

FIG. 22C is a schematic partial exploded perspective view of a component shown as a steering wheel with an airbag system according to an exemplary embodiment.

FIG. 23A is a schematic perspective view of a component shown as a steering wheel with an airbag system according to an exemplary embodiment.

FIG. 23B is a schematic partially exploded section perspective view of a component shown as a steering wheel with an airbag system according to an exemplary embodiment.

FIG. 24A is a schematic cross-section view of a component shown as a steering wheel with an airbag system for a vehicle interior according to an exemplary embodiment.

FIG. 24B is a schematic cross-section exploded view of a component shown as a steering wheel with an airbag system for a vehicle interior according to an exemplary embodiment.

FIGS. 25A through 25C are schematic cross-section views of a component shown as a steering wheel with an airbag system for a vehicle interior according to an exemplary embodiment.

FIGS. 26A through 26C are schematic cross-section views of a component shown as a steering wheel with an airbag system for a vehicle interior according to an exemplary embodiment.

FIGS. 27A through 27D are schematic cross-section views of a component shown as a steering wheel with an airbag system for a vehicle interior according to an exemplary embodiment.

FIGS. 27E and 27F are schematic cutaway section views of a member and retaining member of an airbag system for a vehicle interior according to an exemplary embodiment.

FIGS. 28A through 28C are schematic cross-section views of a component shown as a steering wheel with an airbag system for a vehicle interior according to an exemplary embodiment.

FIGS. 29A through 29C are schematic cross-section views of a component shown as a steering wheel with an airbag system for a vehicle interior according to an exemplary embodiment.

FIG. 30A is a schematic perspective view of a component shown as a steering wheel with an airbag system for extended deployment according to an exemplary embodiment.

FIGS. 30B through 30D is a schematic exploded/partial side view of a tether/member for an airbag of an airbag system for a vehicle interior according to an exemplary embodiment.

FIGS. 30E and 30F are schematic side views of an airbag section of an airbag system for a vehicle interior according to an exemplary embodiment.

FIG. 30G is a schematic cross-section view of a component shown as a steering wheel with an airbag system for a vehicle interior according to an exemplary embodiment.

FIGS. 31A through 31D are schematic cross-section views of an airbag system for a vehicle interior according to an exemplary embodiment.

FIGS. 32A through 32C are schematic cross-section views of an airbag system for a vehicle interior according to an exemplary embodiment.

FIG. 33A is a schematic side elevation view of a vehicle interior with a component shown as a steering wheel with an airbag system for deployment of an airbag according to an exemplary embodiment.

FIG. 33B is a schematic cutaway section view of a retainer of an airbag system for a vehicle interior according to an exemplary embodiment.

FIG. 34A is a schematic side elevation view of a vehicle interior with a component shown as a steering wheel with an airbag system for deployment of an airbag according to an exemplary embodiment.

FIG. 34B is a schematic cutaway section view of a retainer of an airbag system for a vehicle interior according to an exemplary embodiment.

FIGS. 35A and 35B are schematic partial section views of a retainer of an airbag system for a vehicle interior according to an exemplary embodiment.

FIGS. 36A and 36B are schematic partial section views of a retainer of an airbag system for a vehicle interior according to an exemplary embodiment.

FIGS. 37A and 37B are schematic partial perspective views of a retainer of an airbag system for a vehicle interior according to an exemplary embodiment.

FIGS. 38A through 38C are schematic cross-section views of an airbag system for a vehicle interior according to an exemplary embodiment.

FIG. 39A is a schematic partial perspective view of an airbag system for a vehicle interior according to an exemplary embodiment.

FIG. 39B is a schematic partial perspective view of an airbag system for a vehicle interior according to an exemplary embodiment.

FIG. 40A is a schematic block diagram of an airbag system for a vehicle interior according to an exemplary embodiment.

FIG. 40B is a schematic block diagram of an airbag system for a vehicle interior according to an exemplary embodiment.

FIG. 41A is a schematic flow diagram of a method of operation of an airbag system for a vehicle interior according to an exemplary embodiment.

FIG. 41B is a schematic flow diagram of a method of operation of an airbag system for a vehicle interior according to an exemplary embodiment.

FIG. 42A is a schematic flow diagram of a method of operation of an airbag system for a vehicle interior according to an exemplary embodiment.

FIG. 42B is a schematic flow diagram of a method of operation of an airbag system for a vehicle interior according to an exemplary embodiment.

FIG. 43 is a schematic flow diagram of a method of operation of an airbag system for a vehicle interior according to an exemplary embodiment.

### DESCRIPTION

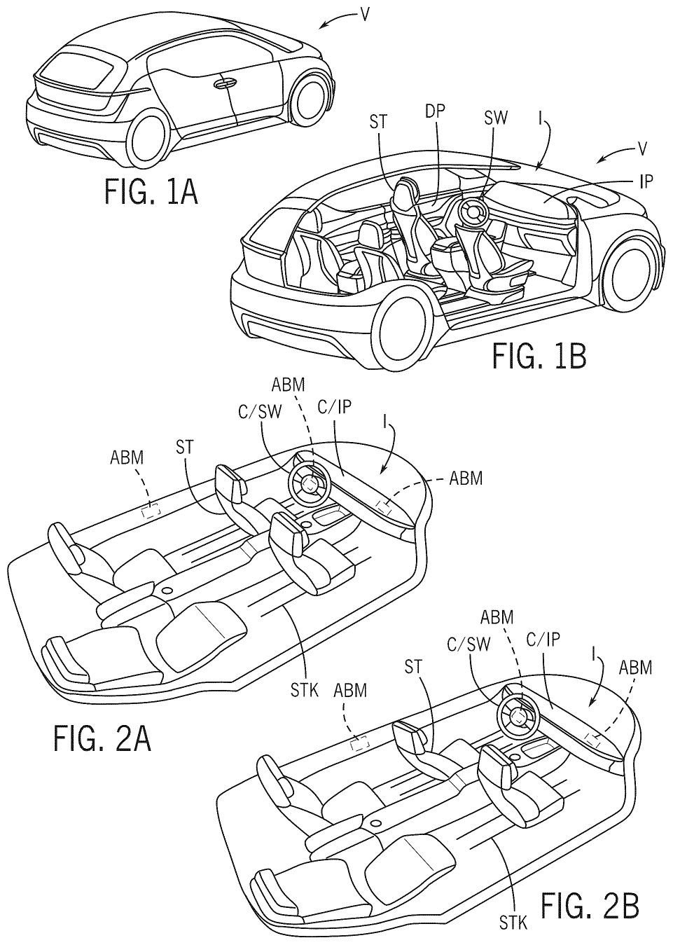

Referring to FIGS. 1A-1B, a vehicle V is shown comprising an interior I with components C such as an operator control shown as steering wheel SW and seats ST (for the operator and occupants) and an instrument panel IP and a door panel DP and other trim/trim panels, etc.

As shown schematically according to an exemplary embodiment in FIGS. 1A-1B, 2A-2B, 3A-3B and 4A-4B, vehicle V may comprise a conventional vehicle operated by an operator-occupant and/or vehicle V may be configured to operate in an autonomous mode in which an operator may not be fully engaged with operator controls. As indicated schematically in FIGS. 2A-2B, 3A-3B and 4A-4B, the operator and/or occupants of the vehicle may be seated on seats ST movable to varying positions within the interior (such as along a track system/track STK); seats may comprise a restraint system/seat belts SB.

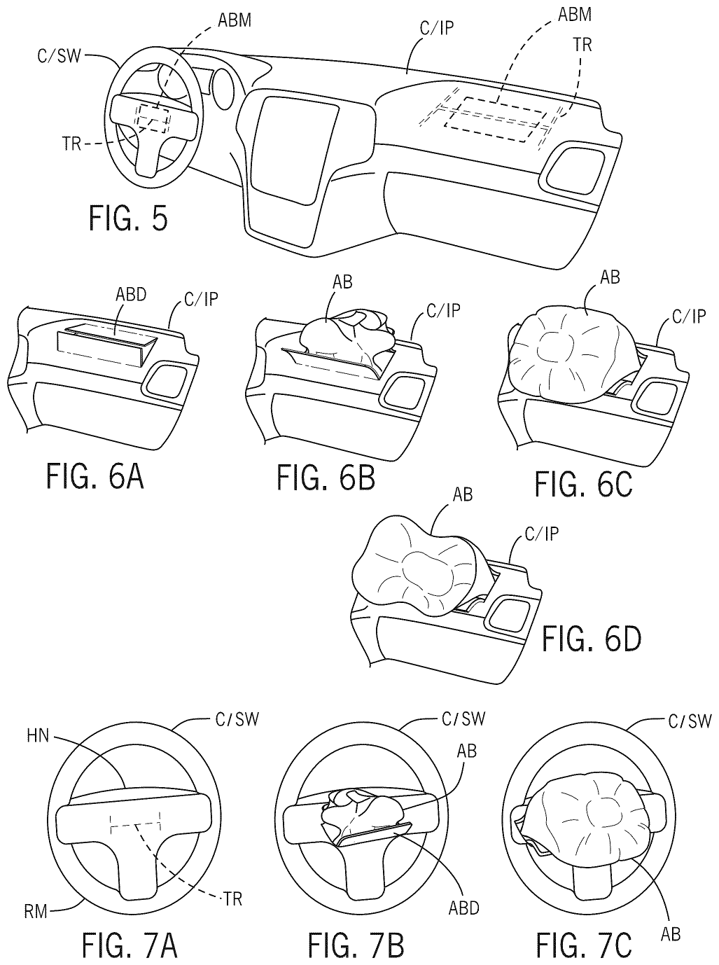

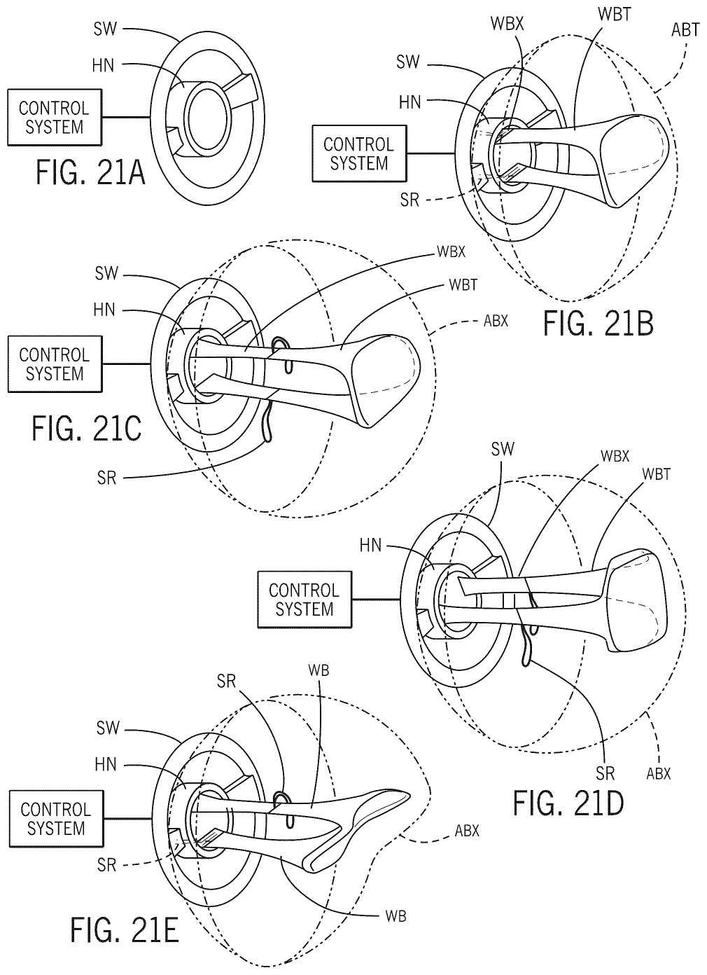

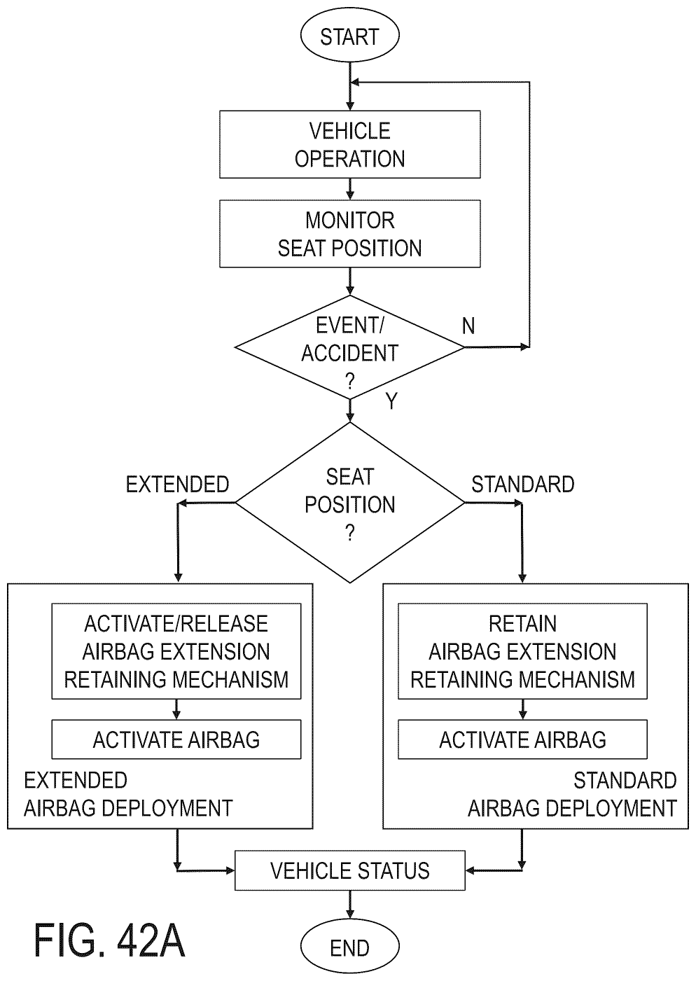

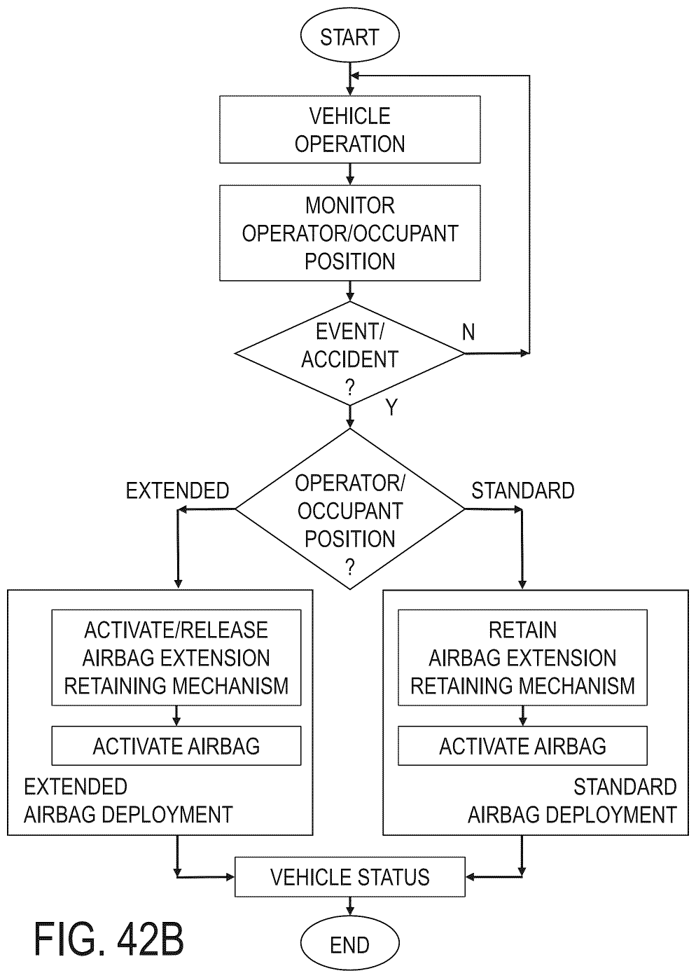

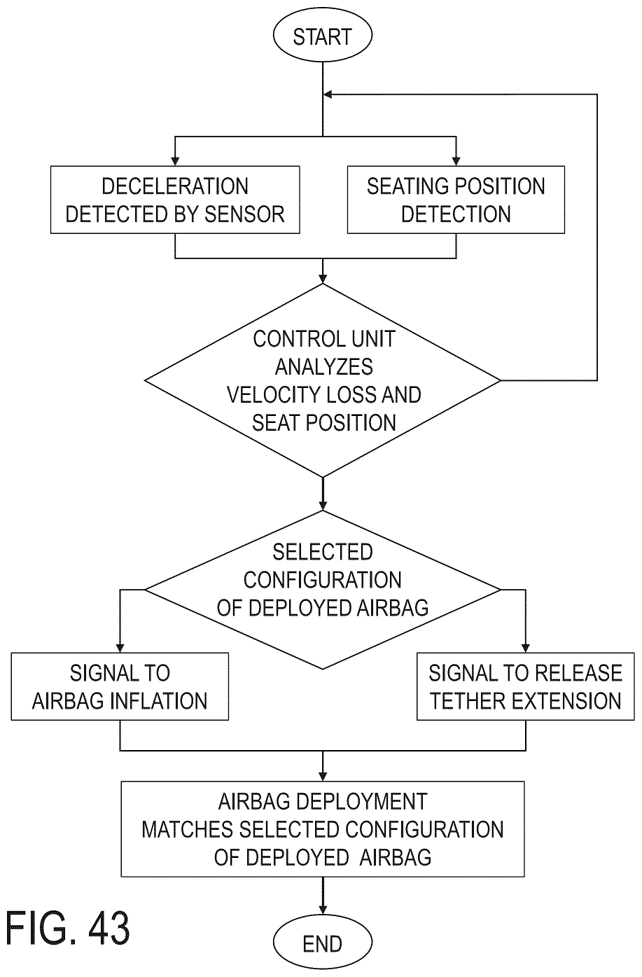

As shown schematically according to an exemplary embodiment in FIGS. 2A-2B, 3A-3B, 4A-4B, 5, 6A-6D and 7A-7C, the interior of the vehicle may comprise an airbag system shown as with an airbag module ABM configured to deploy an airbag AB from a component C and/or through a trim panel into the interior upon detection of an event such as an accident or sudden acceleration/deceleration, etc.; the airbag system may be configured to be operated by a control system (e.g. electronic control unit, microcontroller, etc.). See also FIGS. 21A-21E, 40A-40B, 41A-41B, 42A-42B and 43.

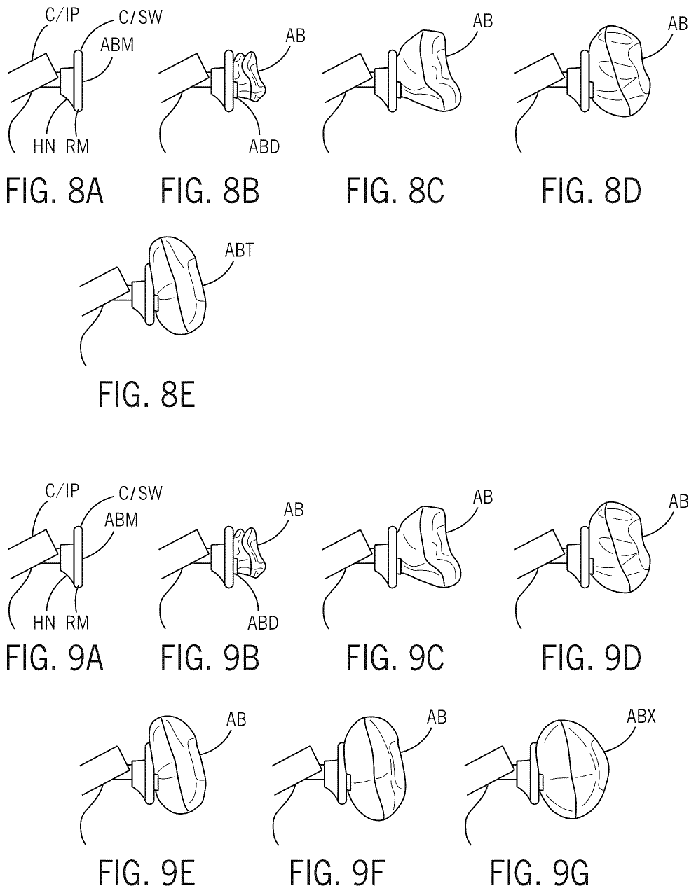

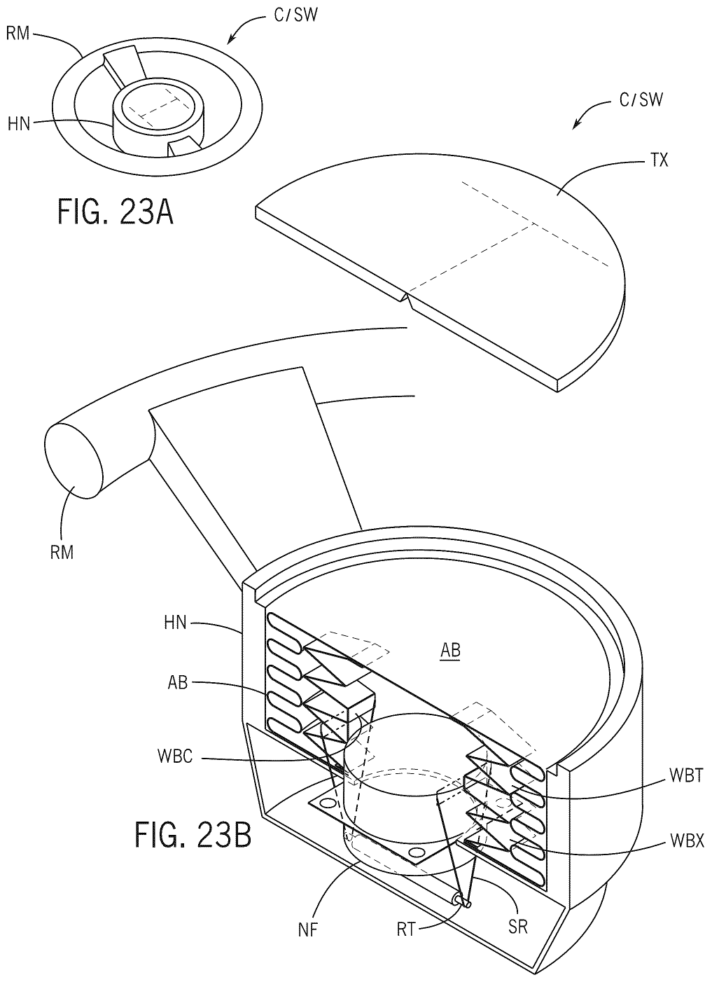

As indicated schematically in FIGS. 2A-2B, 3A-3B, 4A-4B, 5, 6A-6D and 7A-7C, the airbag AB may be deployed from the airbag module ABM through an airbag door ABD such as formed at a weakening/seam shown as tear line TR in the trim panel shown as instrument panel IP or through a cover TX for a housing HN within the rim RM of a steering wheel SW. See also FIGS. 8A-8E, 9A-9G, 22A-22B and 23A-23B.

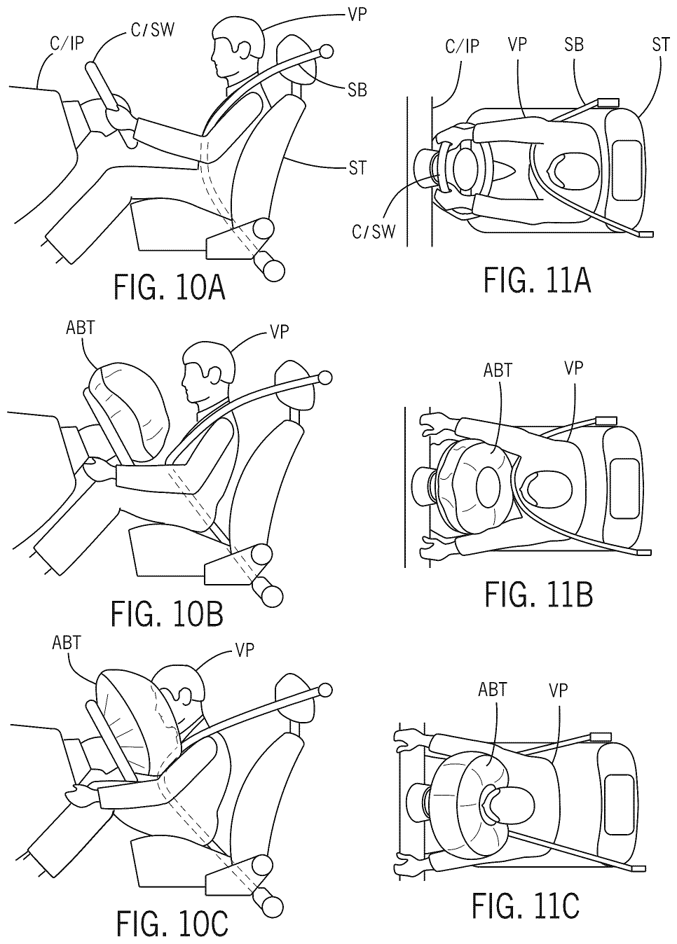

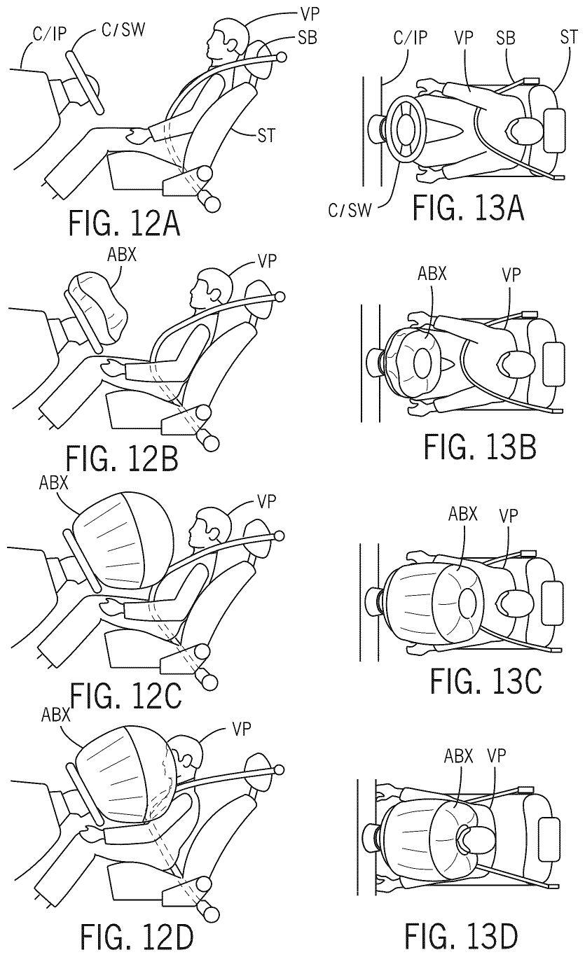

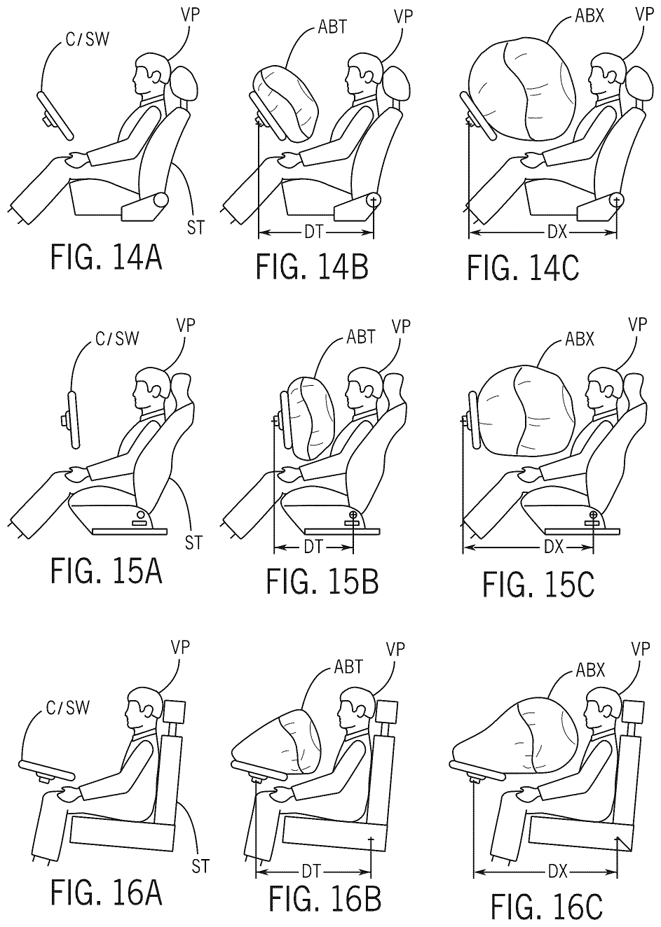

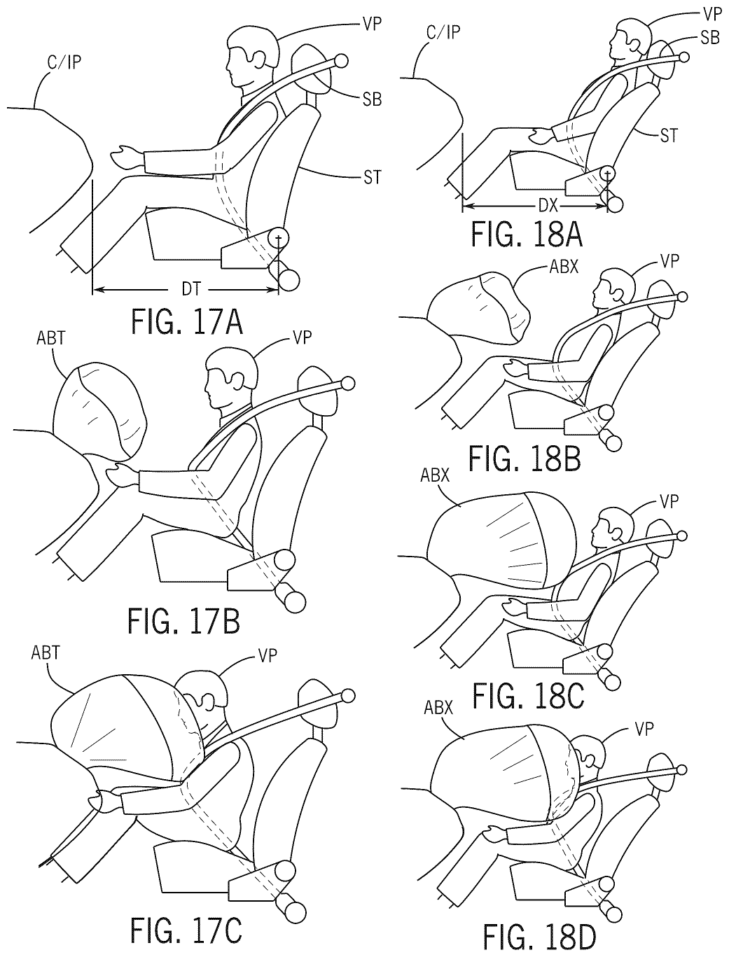

As shown schematically according to an exemplary embodiment in FIGS. 2A-2B, 3A-3B, 4A-4B, 14A-14C, 15A-15C, 16A-16C, 17A-17C, 18A-18D, 33A and 34A, the position of the seat ST and/or occupant VP of the seat in the interior of the vehicle may vary according to the vehicle type or mode of vehicle operation and/or other factors from a standard position between a generally standard position indicated as distance DT to an extended position indicated as distance DX (e.g. with seat ST reclined and/or moved such as along track STK). See also FIGS. 10A-10C, 11A-11C, 12A-12D and 13A-13D. As indicated schematically in FIGS. 2A-2B, 3A-3B, 4A-4B, 8A-8E and 9A-9E, the airbag system may be configured to provide for deployment of the airbag AB in a standard deployment ABT for a seat/occupant in a standard position (shown as at distance DT) and in an extended deployment ABX for a seat/occupant in an extended position (shown as distance DX). See also FIGS. 14A-14C, 15A-15C, 16A-16C, 17A-17C, 18A-18D, 33A and 34A.

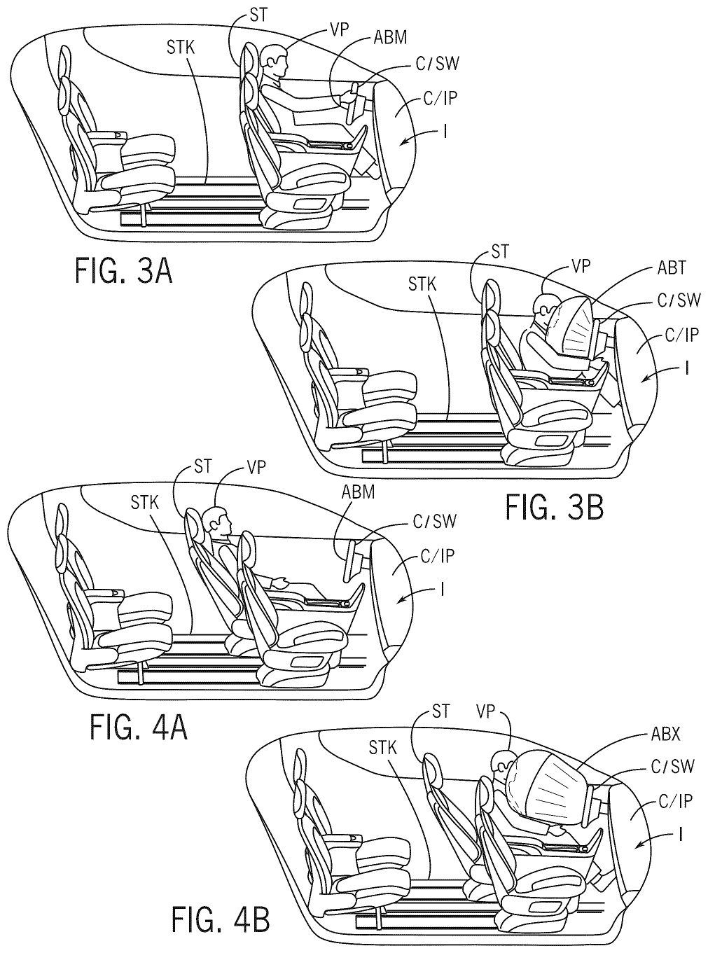

As indicated schematically in FIGS. 14A-14C, 15A-15C and 16A-16C, a vehicle may provide a steering wheel SW and seat ST in a variety of combinations and orientations such as at generally standard distance DT with generally standard deployment of airbag ABT and at extended distance DX with extended deployment of airbag ABX; the airbag system can be configured in an effort to provide for deployment of the airbag AB for the combination/orientation of the vehicle in use by configuration of the airbag system for airbag deployment in a standard form ABT or an extended form ABX. Compare FIGS. 3A-3B, 8A-8E, 14B, 15B, 16B, 17A-17C and 19A-19B (standard) with FIGS. 4A-4B, 9A-9G, 14C, 15C, 16C, 18A-18D and 20A-20B (extended).

As shown schematically according to an exemplary embodiment in FIGS. 3A-3B, 4A-4B, 8A-8E, 9A-9G, 14A-14C, 15A-15C, 16A-16C, 17A-17C, 19A-19B and 20A-20B, standard deployment of airbag ABT in standard form is configured for seat ST and/or occupant VP at standard distance DT (e.g. from airbag system and/or trim panel/component); extended deployment of airbag ABX in extended form is configured for seat ST and/or occupant VP at extended distance DX.

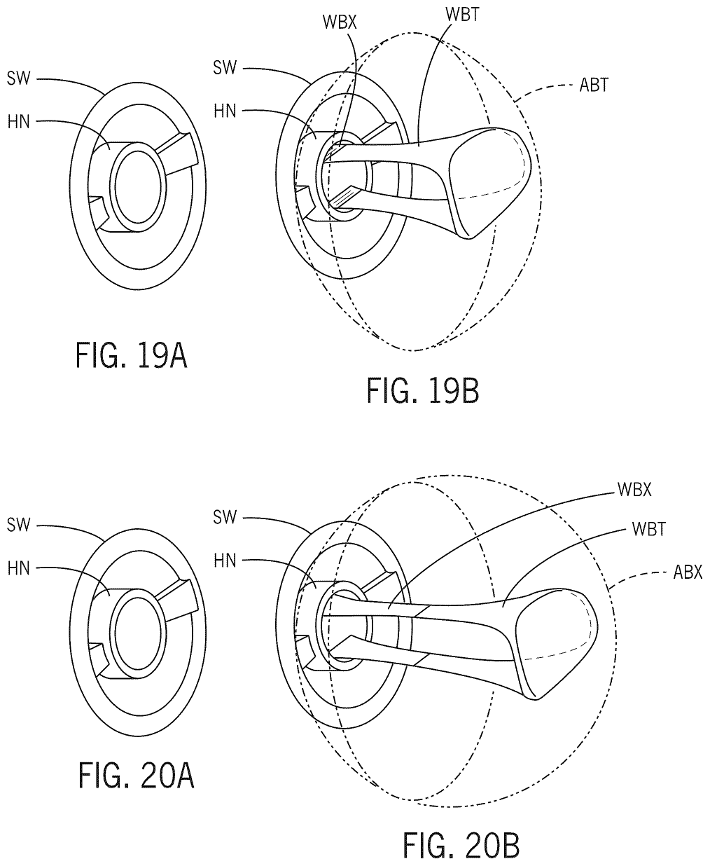

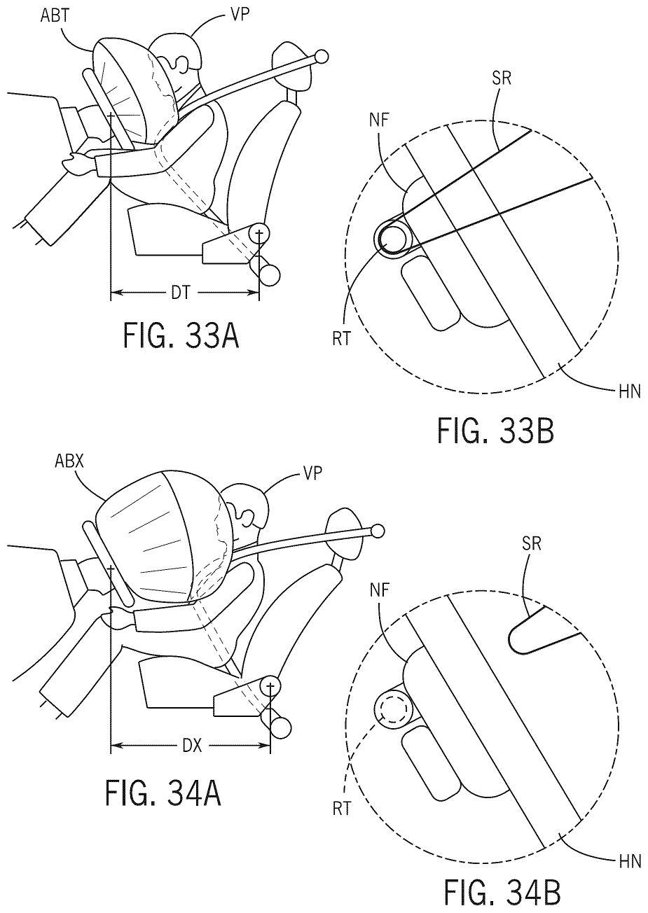

As shown schematically according to an exemplary embodiment in FIGS. 2A-2B, 19A-19B, 20A-20B and 21A-21E, the component shown as steering wheel SW may comprise a housing HN configured for an airbag module/system configured for deployment of an airbag AB; the airbag system may comprise a member shown as a tether/web WB for the airbag and a retainer/retaining member shown as a strap/rope SR connected to the tether/web WB; as shown schematically, the tether/web for the airbag may comprise a standard deployment section WBT and an extended deployment section WBX; for standard deployment of the airbag ABT the standard deployment section WBT is released and the extended deployment section WBX is retained by the retainer SR so that the airbag takes the standard form; for extended deployment of the airbag ABX the standard deployment section WBT is released and the extended deployment section WBX is released from the retainer SR so that the airbag takes the extended form. Compare FIGS. 3A-3B, 8A-8E, 14B, 15B, 16B, 17A-17C, 19A-19B and 21B (airbag deployed in standard form) with FIGS. 4A-4B, 9A-9G, 14C, 15C, 16C, 18A-18D, 20A-20B and 21C-21D (airbag deployed in extended form). See also FIGS. 33A-33B and 34A-34B. As shown schematically in FIGS. 19A-19B, 20A-20B and 21A-21E, the member shown as tether/web WB for the airbag AB may comprise a dual set of members; the members for the airbag may be oriented/aligned in a generally vertical arrangement and/or in a generally horizontal arrangement (or in any of a variety of other arrangements). Compare FIGS. 19A-19B, 20A-20B, 21B-21C (vertical arrangement of tether/web WB) with FIGS. 21D-21E (horizontal arrangement of tether/web WB).

As indicated schematically in FIGS. 21A-21E, 40A-40B, 41A-41B, 42A-42B and 43, the airbag system may be configured for operation by a control system with a program/method configured to provide for deployment upon detection of an event in a standard deployment of airbag ABT or in an extended deployment of airbag ABX (e.g. full extended deployment or partial extended deployment); standard deployment of airbag ABT by retaining of the retainer may be directed by the control system when the seat/position of an occupant is in a standard position/distance (DT); extended deployment of airbag ABX by release of the retainer may be directed by the control system when the seat/position of an occupant is in an extended position/distance (DX). See also FIGS. 33A-33B and 34A-34B.

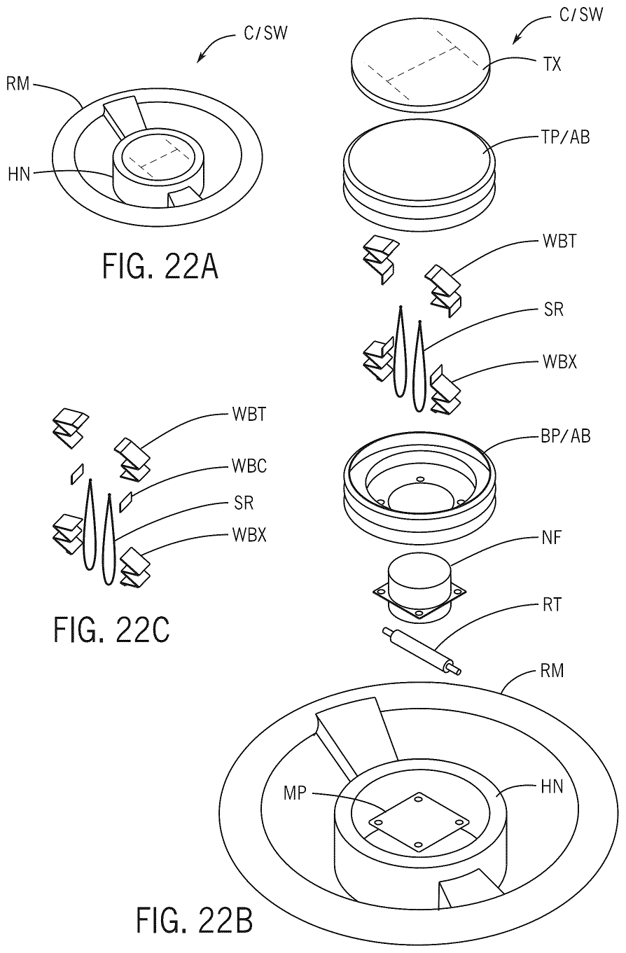

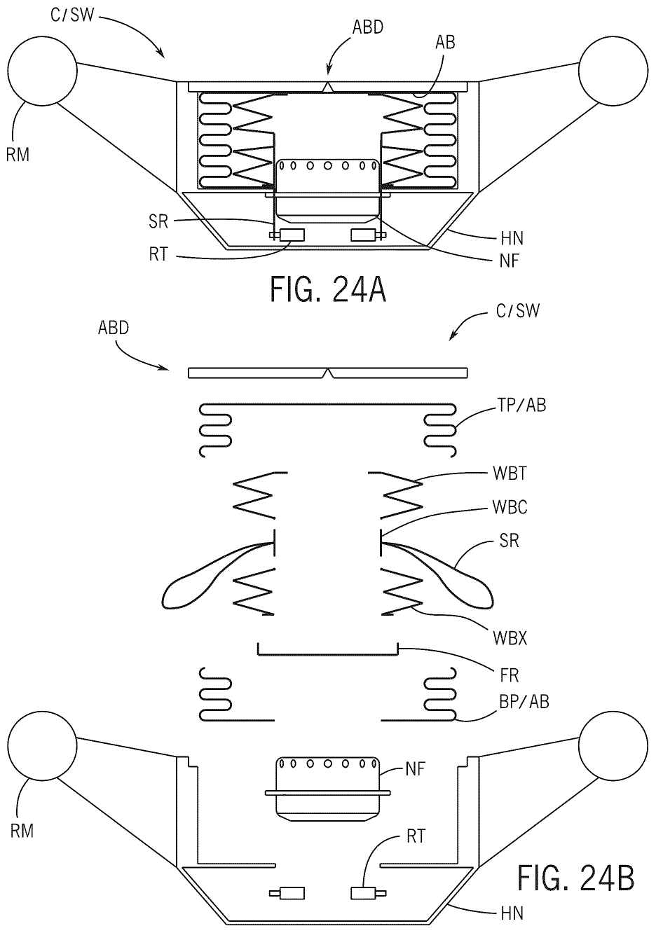

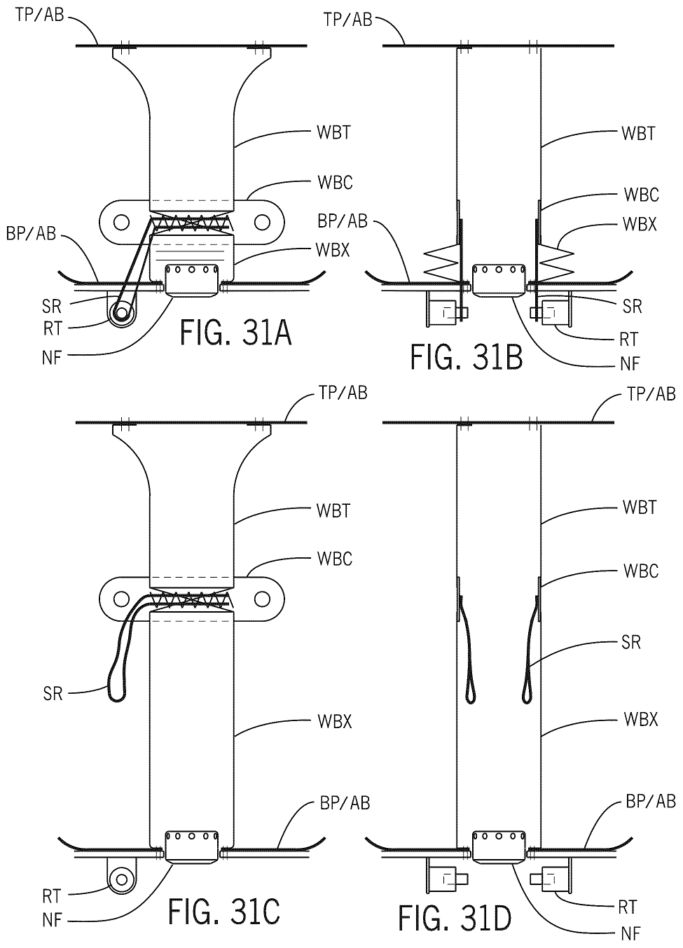

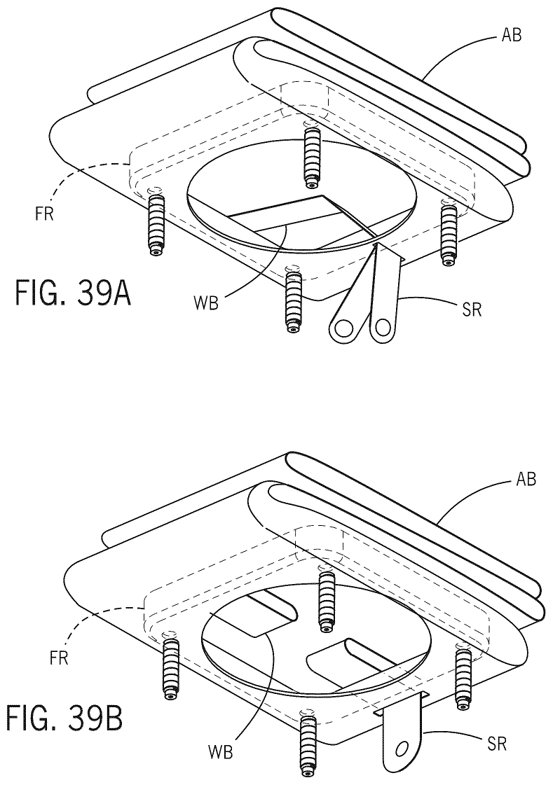

As shown schematically according to an exemplary embodiment in FIGS. 22A-22C, 23A-23B, 24A-24B, 30A-30G, 31A-31D and 39A-39B, the component shown as steering wheel C/SW may comprise a rim RM and housing HN with a cover TX through which an airbag system may deploy an airbag; the airbag system may be mounted by a mounting plate MP in the housing HN; the airbag system may comprise an airbag AB comprising a front shell TP and a rear shell BP (retained at a scam) and a frame FR and an inflator NF (configured to be actuated by the control system to inflate the airbag for deployment); inflation of airbag AB comprises inflation of front shell TP/AB and rear shell BP/AB into a standard form ABT or an extended form ABX. See also FIGS. 19A-19B, 20A-20B and 21A-21E. As shown schematically according to an exemplary embodiment in FIGS. 22A-22C, 23A-23B, 24A-24B, 30A-30G, 31A-31G and 39A-39B, the airbag system may comprise a member shown as tether/web WB provided for the airbag to retain form/shape and size/distance of deployment; web WB may comprise a standard deployment section WBT for the airbag in standard form ABT and an extended deployment section WBX for the airbag in extended form ABX; web WB may comprise an area shown as connection section WBC configured for attachment of the retainer/retaining member SR (e.g. by stitching, adhesive, combination, integration, etc.). Compare FIG. 22B (no connection section) with FIG. 22C (connection section).

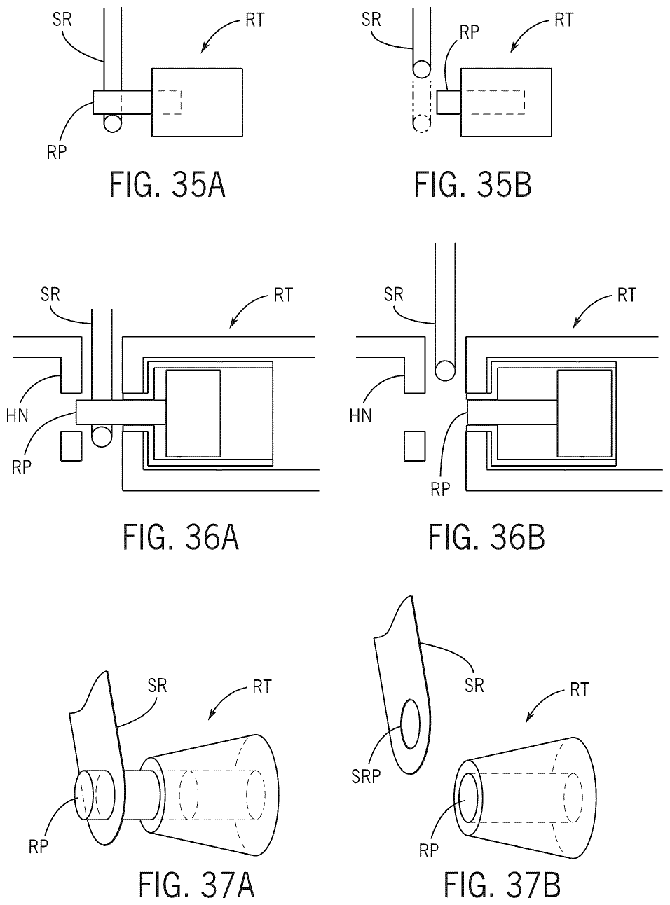

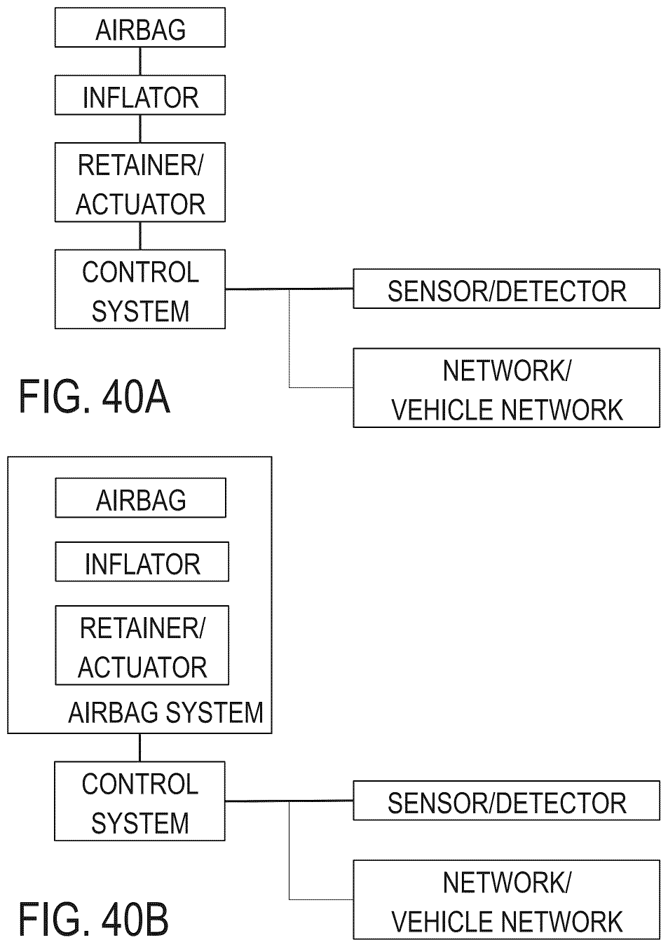

As indicated in FIGS. 22A-22C, 35A-35B, 36A-36B and 37A-37B, the airbag system may comprise the retainer shown as a retaining member SR and a retaining mechanism RT shown as comprising a retaining pin RP configured to engage with retaining member SR through a loop or aperture SRP; as indicated schematically, retaining pin RP may be configured to be extended to retain the retaining member SR and to be retracted to release the retaining member SR. See also FIGS. 33A-33B, 34A-34B and 39A-39B. As indicated schematically in FIGS. 33A-33B and 34A-34B, during deployment of the airbag (e.g. at direction of the control system based on signal/date from vehicle systems/network and/or sensors, detectors, etc.) the retaining mechanism RT is configured to retain retainer/retaining member SR for standard deployment of the airbag ABT and to release retainer/retaining mechanism SR for extended deployment of the airbag ABX. Sec also FIGS. 40A-40B, 41A-41B, 42A-42B and 43.

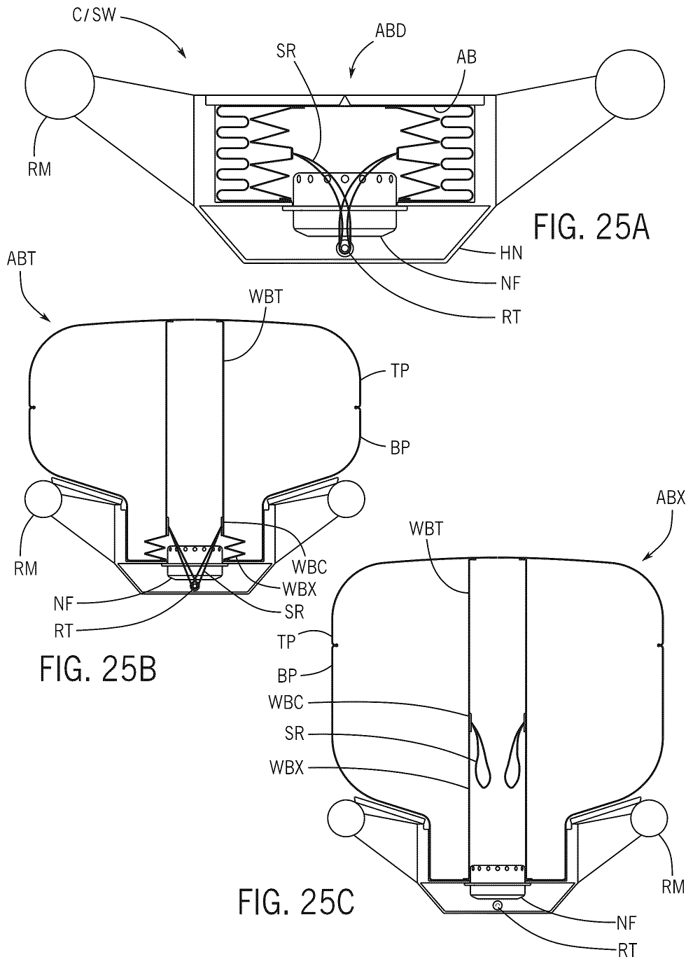

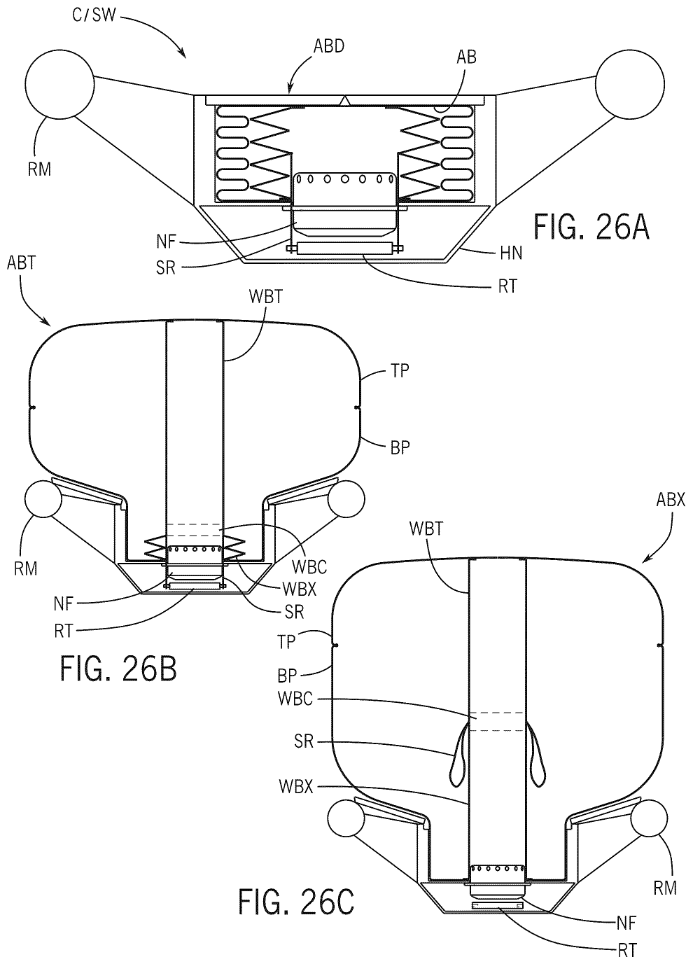

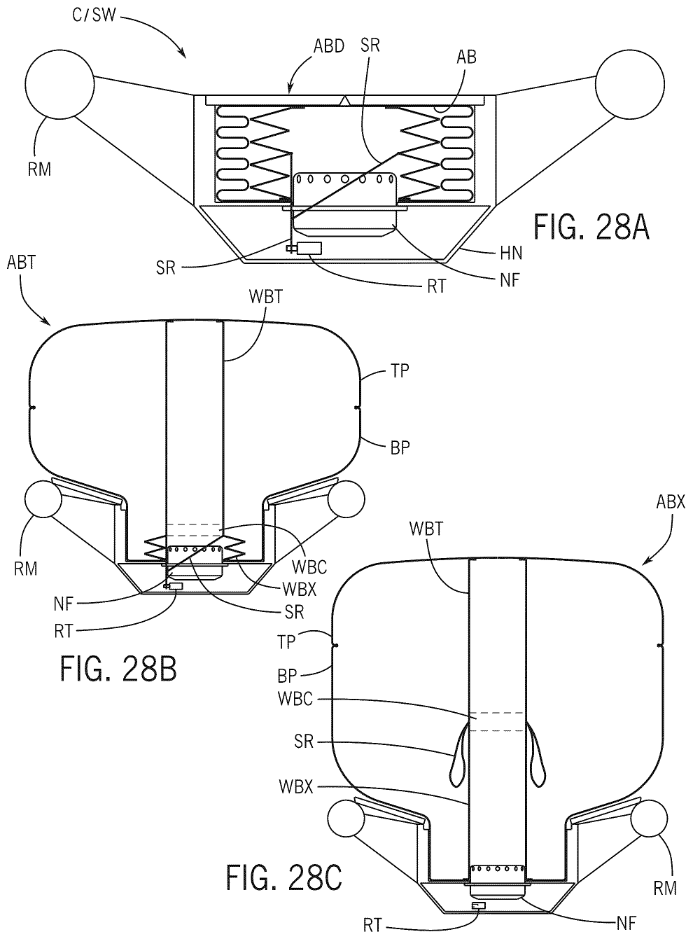

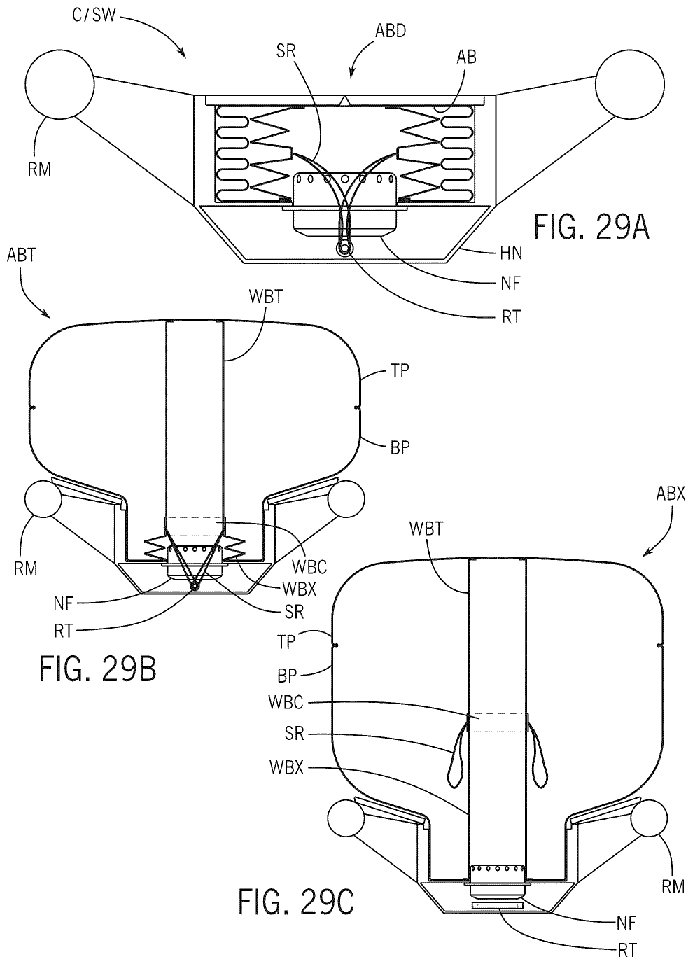

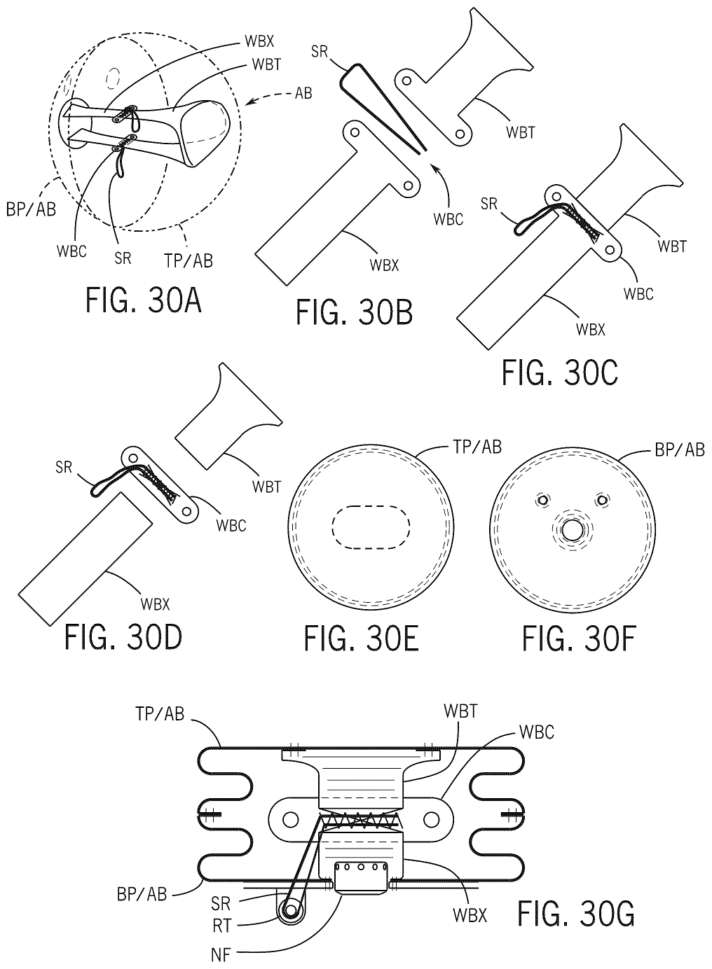

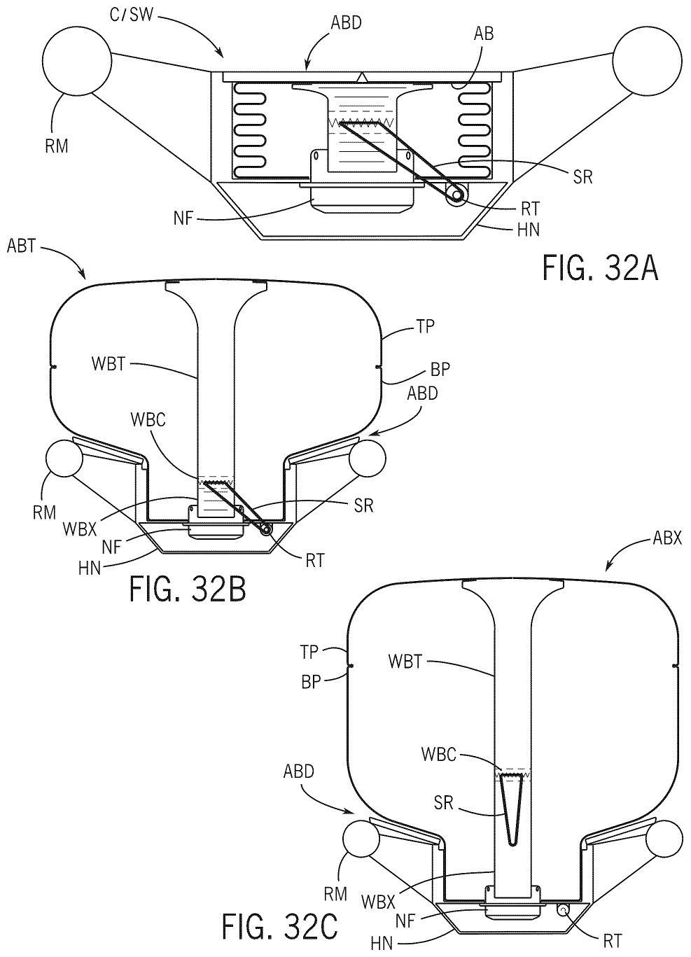

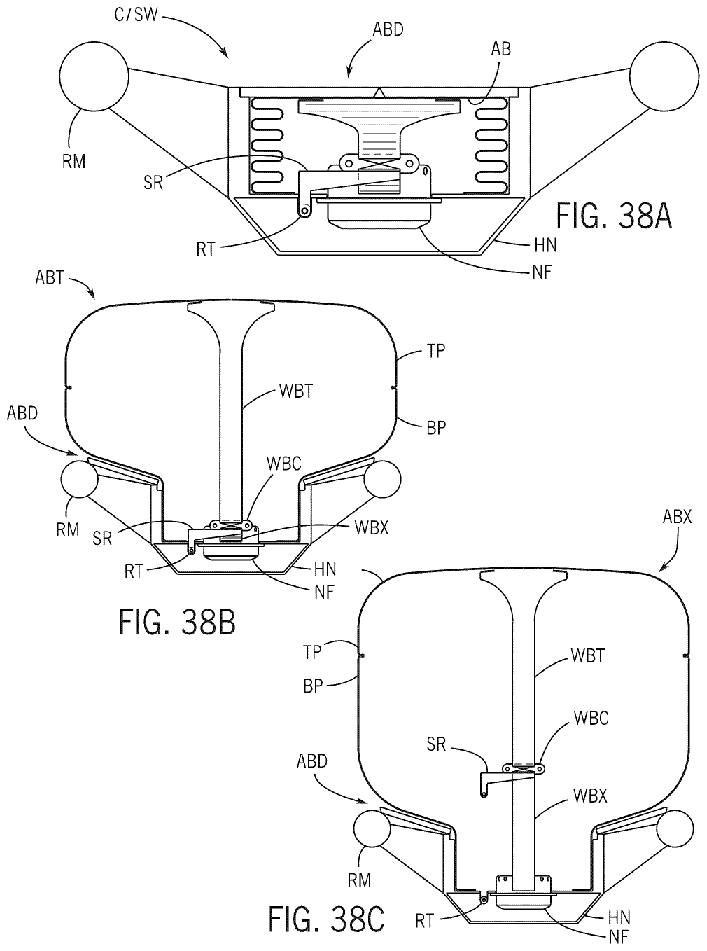

As indicated schematically in FIGS. 22A-22B, 23A-23B, 24A-24B, 25A-25C, 26A-26C, 27A-27F, 28A-28C, 29A-29C, 32A-32C and 38A-38C, the airbag system may be provided in a variety of configurations for a trim panel or component shown as steering wheel SW; the airbag AB may be configured with the tether/web arrangement WB attached to the retainer/retaining member SR and retaining mechanism RT; the retaining member/retainer SR may comprise one retaining member SR (e.g. FIGS. 32A-32C and 38A-38C) or a set of retaining members (e.g. FIGS. 25A-25C, 26A-26C, 27A-27F, 28A-28C, 29A-29C) configured for attachment to the airbag through the member/tether WB and for actuation (retain/release) at the retainer mechanism RT. See FIGS. 30A-30G, 31A-31G and 39A-39B.

As indicated schematically in FIGS. 25A-25C, 26A-26C, 27A-27F, 28A-28C, 29A-29C, 32A-32C and 38A-38C, the airbag system (e.g. at direction of the control system based on signal/date from vehicle systems/network and/or sensors, detectors, etc.) is configured to use the retaining mechanism RT to retain retainer/retaining member SR to release the standard deployment section of web WBT for standard deployment of the airbag into standard form ABT and to release retainer/retaining mechanism SR to release the extended deployment section of the web WBX for extended deployment of the airbag into extended form ABX. See also FIGS. 40A-40B, 41A-41B, 42A-42B and 43.

As indicated schematically in FIGS. 6A-6C, 19A-19B, 20A-20B, 21A-21D and 27A-27C, the airbag system may be configured for deployment of the airbag ABX in a generally symmetrical form. As indicated schematically in FIGS. 6D, 21E and 27D, the airbag system may be configured for deployment of the airbag ABX in an asymmetrical form.

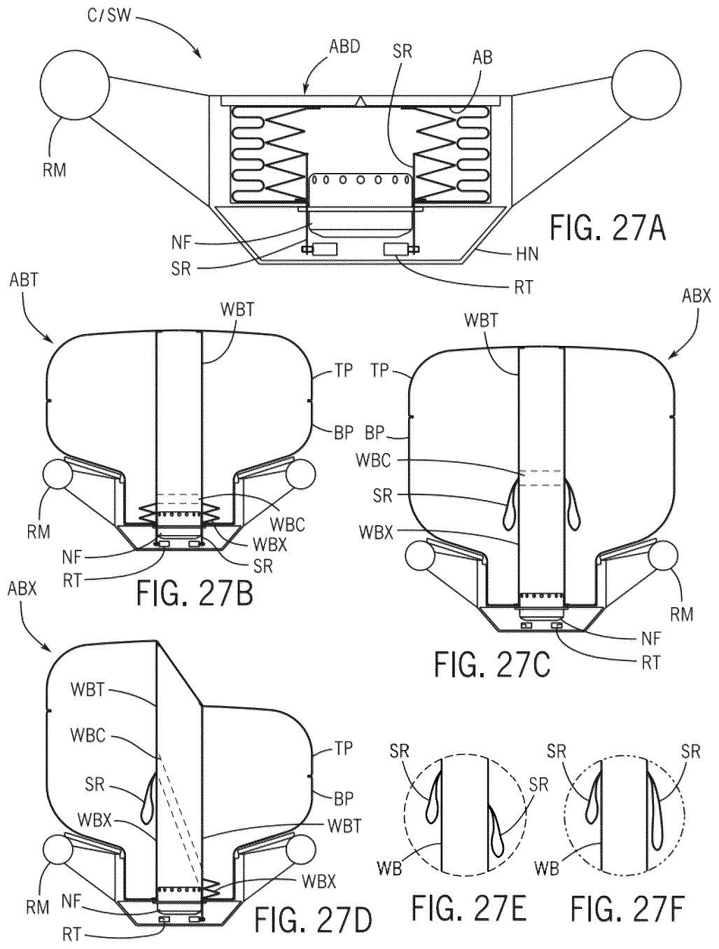

As indicated schematically in FIGS. 21C-21E and 27A-27F, the retaining member/retainer SR may comprise a set of retaining members. Sec also FIGS. 6A-6C and 7A-7C. As indicated schematically in FIGS. 21E and 27D, the extended form of the airbag may comprise an asymmetrical extended form with one retaining member SR released and one retaining member retained for partial extended deployment of the airbag ABX. See also FIG. 6D. As indicated schematically in FIGS. 20B and 21C-21D, the extended form of the airbag may comprise a generally symmetrical extended form with all retaining members SR released for full extended deployment of airbag ABX. See also FIGS. 27A-27C. As indicated schematically in FIGS. 21A-21E, the airbag system may be actuated by a control system configured to actuate the airbag in a partial extended deployment with one retaining member retained SR and in a full extended deployment with all retaining members SR released. As indicated schematically in FIGS. 27D-27F, the retainer may comprise a set of retaining members SR shown as configured to be retained by a set of pins of the retaining mechanism RT (which at deployment can be retained together for standard deployment or released separately/selectively and individually for partial extended deployment or released together for full extended deployment). As shown schematically in FIG. 27D, one retaining member may be retained and one retaining member may be released so that the partially extended form of the airbag may comprise an asymmetrical form of deployment; as shown schematically in FIG. 27E, the set of retaining members may be attached asymmetrically along the member/tether for the airbag so that the partially extended form of the airbag may comprise an asymmetrical form of deployment; as shown schematically in FIG. 27F, one retaining member may comprise a shorter length and one retaining member may comprise a longer length (longer than the shorter length) so that the partially extended form of the airbag may comprise an asymmetrical form of deployment (as will depend upon deployment). See also FIGS. 6D and 21E. (As indicated schematically, in an asymmetrical form the surface of the airbag facing the occupant may be inclined; in a generally symmetrical form the surface of the airbag facing the occupant may be generally parallel.)

According to an exemplary embodiment, the tether/web member for the airbag and for the strap/web retaining member may comprise a polyester fabric, polyamide fabric, PET, PES, polyamide webbing, polyester webbing, etc.

According to an exemplary embodiment, the volume of the airbag for standard deployment may comprise 55-65 liters; the volume of the airbag for extended deployment may comprise 65-80 liters and/or a larger or smaller volume adapted for the extended position of occupant in the vehicle (e.g. conventional mode/operation, autonomous mode/operation, seat position movement range, etc.).

### Exemplary Embodiments—A

According to an exemplary embodiment as shown schematically in FIGS. 2A-2B, 3A-3B, 4A-4B, 8A-8E, 9A-9G, 19A-19B, 20A-20B, 21A-21E, 22A-22C, 23A-23C, 24A-24B, 30A, 33A-33B, 34A-34B and 40A-40B, a component for an interior of a vehicle V configured for deployment of an airbag AB for an occupant in a seat ST of the vehicle upon an event may comprise (a) an airbag AB configured to be inflated for deployment; (b) a retaining mechanism RT; and (c) a retaining member SR configured to be retained by the retaining mechanism RT for standard deployment of the airbag and to be released by the retaining mechanism RT for extended deployment of the airbag. In standard deployment the airbag may be inflated in a standard form ABT; the standard form ABT may have a size of 55 to 65 liters. In extended deployment the airbag may be inflated in an extended form ABX; the extended form ABX may have a size of 65 to 80 liters. The retaining member SR may comprise a flexible member. The component may comprise a member WB for the airbag. The member WB for the airbag may be configured to provide for standard deployment of the airbag. The member WB for the airbag may comprise a tether arrangement. The member may comprise a tether coupled to the retaining member SR. The member WB for the airbag may comprise a flexible web material; the web material may comprise polyester and/or polyamide. The member WB for the airbag may comprise (1) a section configured to retain the airbag for standard deployment and (2) a section configured to release for extended deployment. The member WB for the airbag may comprise a connection to the retaining member SR. The member WB for the airbag may comprise (1) a section configured to retain the airbag for standard deployment and (2) a section configured to release for extended deployment and (3) a connection for the retaining member SR. The member WB for the airbag may comprise a fabric material. The member WB for the airbag may comprise a standard deployment section WBT and an extended deployment section WBX. The standard deployment section WBT may be deployed for standard deployment. The standard deployment section WBT and the extended deployment section WBX are deployed for extended deployment. The member WB for the airbag may comprise a standard deployment section WBT and an extended deployment section WBX. The retaining member SR may be coupled to the member so that (1) the extended deployment section WBX may be retained by the retaining member SR and the standard deployment section WBT is deployed for standard deployment and (2) the extended deployment section WBX may be released by the retaining member SR and the standard deployment section WBT and the extended deployment section WBX are deployed for extended deployment. The member WB for the airbag may comprise a connection section WBC between the standard deployment section WBT and the extended deployment section WBX; the retaining member SR may be connected to the connection section WBC. The member WB for the airbag may be within the airbag. The member WB for the airbag may be coupled to the retaining member SR for standard deployment. The member WB for the airbag may be uncoupled from the retaining member SR for extended deployment. The extended form ABX may be larger than the standard form ABT. In the extended form ABX the airbag may extend further than in the standard form ABT. The component may comprise an airbag system comprising an airbag module comprising the airbag. The airbag system may comprise the inflator and the retaining member SR. The airbag system may comprise a member WB for the airbag coupled to the retaining member SR and configured to retain the airbag for standard deployment. The component may comprise an inflator configured to inflate the airbag for deployment. The component may comprise an airbag system comprising the airbag and a control system. The control system may be configured to be operated by a signal from a vehicle system. The control system may be configured to be operated by a signal from a vehicle system representative of position of the seat for the occupant. The control system may be configured to be operated by a signal from a vehicle system representative of position of the occupant. The control system may be configured to be operated by a signal from a sensor or detector within the vehicle interior. The control system may be configured to be operated by a signal representative of the position of the seat for the occupant. The control system may be configured to be operated by a signal representative of the position of the occupant. The control system may be configured to be operated by a signal from a camera. The control system may be configured to actuate the retaining mechanism RT for extended deployment of the airbag. The component may comprise a control system configured to actuate the inflator and to operate the retaining mechanism RT for extended deployment of the airbag. The control system may comprise an electronic control unit. The control system may be configured to actuate the inflator based on a deployment signal indicating the event. The event may comprise detection of a change in acceleration of the vehicle. The event may comprise detection of a rapid deceleration of the vehicle. The event may comprise detection of an accident involving the vehicle. The control system may be configured to actuate the retaining mechanism RT to facilitate extended deployment based upon a signal. The signal may comprise a signal indicating position of the occupant. The signal may comprise a signal indicating position of the seat with the occupant. The signal may comprise a signal from a sensor. The signal may comprise a signal indicating the position of a seat or an occupant at a distance beyond a threshold distance. If the distance is within the threshold distance the retaining mechanism RT may be configured to retain for standard deployment; if the distance is greater than the threshold distance the retaining mechanism RT may be configured to release for extended deployment. The retaining mechanism RT may be configured to retain the retaining member SR for standard deployment and to release the retaining member SR for extended deployment. The retaining member SR may comprise a strap. The retaining member SR may comprise a rope. The retaining member SR may comprise a flexible member. The retaining member SR may comprise a loop. The retaining mechanism RT may comprise a pin; the retaining member SR may comprise an aperture configured to be retained by the pin. The retaining mechanism RT may be configured to retract the pin to release the retaining member SR for extended deployment of the airbag. The retaining member SR may be configured to be retained by the pin of the retaining mechanism RT for standard deployment and to be released by the pin of the retaining mechanism RT for extended deployment. The retaining mechanism RT may comprise an actuator actuated by the control system. The retaining mechanism RT may comprise a retaining pin configured to be actuated by the actuator. The retaining mechanism RT may be configured to retain the retaining member SR on the retaining pin for standard deployment. The retaining mechanism RT may be configured to release the retaining member SR at the retaining pin for extended deployment. The retaining pin may be configured to be retracted for extended deployment. The retaining pin may be configured to be extended for standard deployment and to be retracted for extended deployment. The retaining member SR may comprise an aperture configured for engagement with the retaining pin. The aperture may be engaged with the retaining pin for standard deployment. The aperture may be disengaged from the retaining pin for extended deployment. The component may comprise a trim panel configured to provide an airbag door formed at deployment of the airbag. The trim panel may comprise an instrument panel C/IP. The airbag may be configured to deploy from the instrument panel C/IP. The trim panel may be provided on a steering wheel C/SW. The airbag may be configured to deploy from a steering wheel C/SW. The airbag may be configured to deploy from a trim panel.

According to an exemplary embodiment as shown schematically in FIGS. 2A-2B, 3A-3B, 4A-4B, 8A-8E, 9A-9G, 19A-19B, 20A-20B, 21A-21E, 22A-22C, 23A-23C, 24A-24B, 30A, 33A-33B, 34A-34B and 40A-40B, an airbag system for a vehicle interior component for an interior of a vehicle configured for deployment of an airbag for an occupant in a seat of the vehicle upon an event may comprise (a) an airbag configured for deployment in standard deployment or extended deployment; (b) an inflator configured to inflate the airbag for deployment; (c) a retainer SR configured to retain for standard deployment and to release for extended deployment; and (d) a control system configured to actuate the inflator and to operate the retainer SR. The control system may be configured to actuate the retainer SR for extended deployment of the airbag. The airbag may comprise a member. In standard deployment the airbag may be inflated in a standard form ABT. In extended deployment the airbag may be inflated in an extended form ABX. The airbag may comprise a front shell and a rear shell. The retainer SR may be configured to retain the rear shell of the airbag at least partially for standard deployment and to release the rear shell of the airbag fully for extended deployment. The member may comprise a tether arrangement comprising a web of material. The tether arrangement may comprise a flexible tether. The retainer SR may comprise a fastening member coupled to the flexible tether. The retainer comprise a retaining member SR coupled to the flexible tether. The system may comprise a retaining mechanism RT comprising the retainer SR; the retainer may comprise a retaining member SR configured to be retained by the retaining mechanism RT for standard deployment and to be released by the retaining mechanism RT for extended deployment. The system may comprise a retaining member SR configured to retain the airbag at a connection to the member for standard deployment and to release the airbag at a connection to the retaining mechanism RT for extended deployment. The system may comprise a retaining member SR configured to retain the airbag at a connection to the member and at a connection to the retaining mechanism RT for standard deployment and to release the airbag at the connection to the retaining mechanism RT for extended deployment. The retaining member SR may comprise a flexible member. The member may comprise (a) a standard deployment section WBT and an extended deployment section WBX and (b) a retaining member SR coupled to the member and configured to be actuated with the retainer SR to retain the airbag for standard deployment and to release the airbag for extended deployment. The flexible member WB for the airbag may comprise a connection section WBC; the retainer may comprise a retaining member SR connected to the connection section WBC of the member WB for the airbag. The standard deployment section WBT of the member may be released for standard deployment so that the airbag is deployed in standard form ABT. The extended deployment section WBX of the member may be released for extended deployment so that the airbag is deployed in extended form ABX. The retainer SR may be configured to retain the extended deployment section WBX of the member for standard deployment and to release the extended deployment section WBX of the member for extended deployment. The system may be configured to be operated according to a method comprising the steps of (a) monitoring the operation of the vehicle for the event; (b) monitoring position of the occupant and/or seat in the interior of the vehicle; (c) deploying the airbag upon detection of the event (1) in the standard form ABT if the occupant and/or seat is in detected in a standard position or (2) in the extended form ABX if the occupant and/or seat is detected to be beyond the standard position.

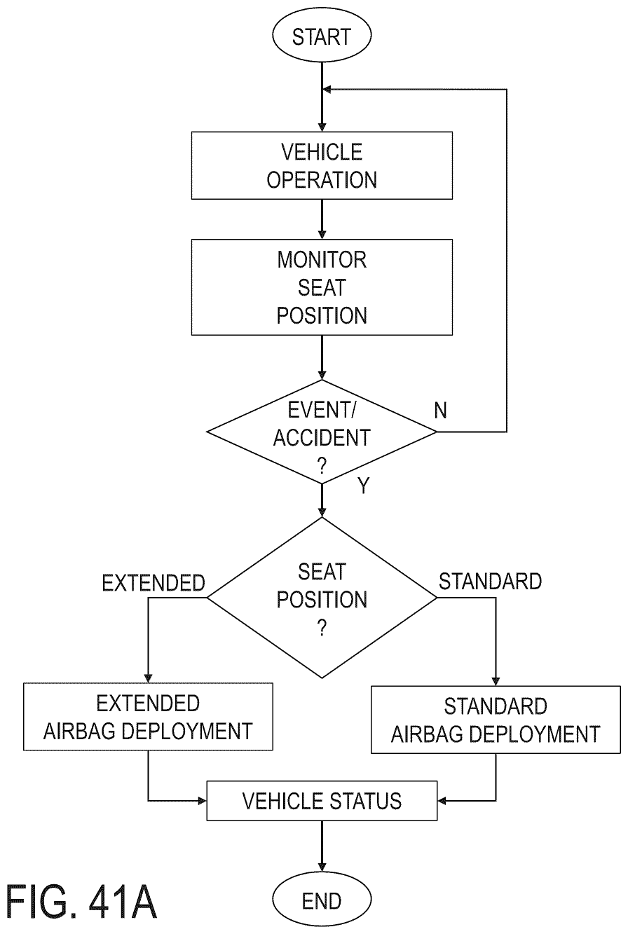

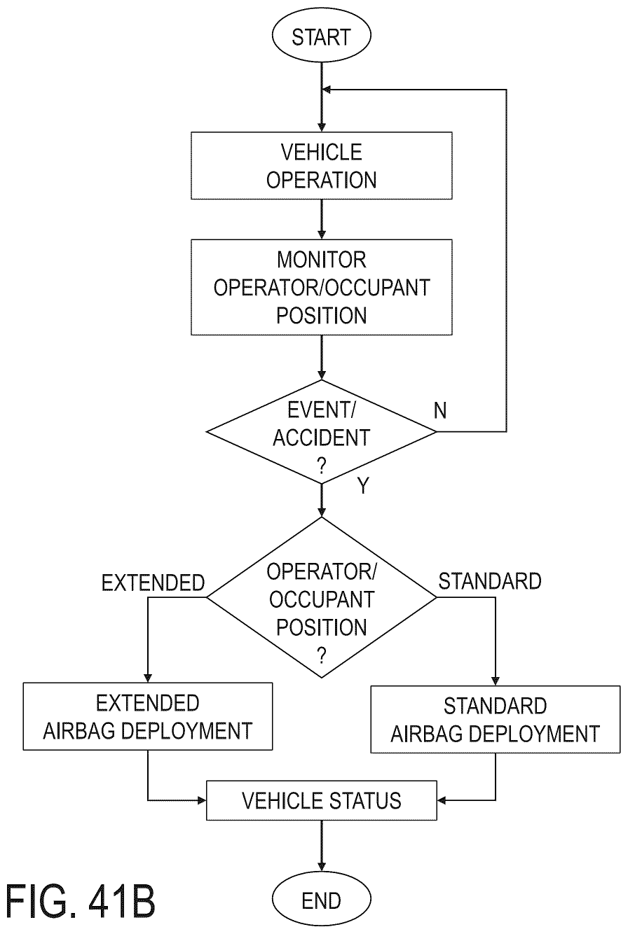

According to an exemplary embodiment as shown schematically in FIGS. 41A-41B, 42A-42B and 43, a method of operation of an airbag system configured for deployment of an airbag into an interior of a vehicle comprising an occupant in a seat may comprise the steps of: (a) monitoring the operation of the vehicle for an event; (b) monitoring position of the occupant and/or seat in the interior of the vehicle; and (c) deploying the airbag upon detection of an event (1) in a standard form ABT if the occupant and/or seat is in a standard position or (2) in an extended form ABX if the occupant and/or seat is beyond the standard position. Sec also FIGS. 2A-2B, 3A-3B, 4A-4B, 8A-8E, 9A-9G, 19A-19B, 20A-20B, 21A-21E, 22A-22C, 23A-23C, 24A-24B, 30A, 33A-33B, 34A-34B and 40A-40B. The airbag may be deployed in standard deployment for standard form ABT and in extended deployment for extended form ABX; the extended form ABX may be larger than standard form ABT. The airbag system may comprise a retaining mechanism RT actuated by the control system and a retaining member SR configured to be retained by the retaining mechanism RT for standard deployment and to be released by the retaining mechanism RT for extended deployment. The airbag system may comprise a member WB for the airbag coupled to a retaining member SR for the airbag; the retaining member SR may be configured to retain the airbag for standard deployment. The member WB for the airbag may comprise a standard deployment section WBT and an extended deployment section WBX; the retaining member SR for the airbag may be coupled to the member and to a retaining mechanism RT; the step of deploying the airbag may comprise retaining the retaining member SR at the retaining mechanism RT for standard deployment and releasing the retaining member SR from the retaining mechanism RT the airbag for extended deployment. The step of deploying the airbag may comprise retaining the retaining member SR at the retaining mechanism RT and to the member WB for the airbag for standard deployment and releasing the retaining member SR from the retaining mechanism RT the airbag for extended deployment. The step of deploying the airbag in the standard form ABT may comprise retaining the member WB for the airbag by the retaining member SR. The step of deploying the airbag in the extended form ABX may comprise disconnecting the retaining member SR from the retaining mechanism RT. The step of deploying the airbag in the extended form ABX may comprise disconnecting the retaining member SR from the retaining mechanism RT without severing the retaining member SR. The step of deploying the airbag in the extended form ABX may comprise disconnecting the retaining member SR intact from the retaining mechanism RT. The retaining member SR may comprise a loop; the step of deploying the airbag in the extended form ABX may comprise disconnecting the loop of the retaining member SR from the retaining mechanism RT. The member may comprise a tether comprising a web of material. The airbag system may comprise the airbag and a control system. The control system may be configured to be operated by a signal from a vehicle system representative of the event. The control system may be configured to be operated by a signal representative of the position of the seat for the occupant. The control system may be configured to be operated by a signal representative of the position of the occupant. The airbag may be configured to deploy from a steering wheel C/SW; the control system may be configured to be operated by a signal representative of the position of the seat for the occupant relative to the steering wheel C/SW. The airbag may be configured to deploy from an instrument panel C/IP; the control system may be configured to be operated by a signal representative of the position of the seat for the occupant relative to the instrument panel C/IP.

According to an exemplary embodiment as shown schematically in FIGS. 2A-2B, 3A-3B, 4A-4B, 8A-8E, 9A-9G, 19A-19B, 20A-20B, 21A-21E, 22A-22C, 23A-23C, 24A-24B, 30A, 33A-33B, 34A-34B and 40A-40B, a component for an interior of a vehicle configured for deployment of an airbag for an occupant in a seat of the vehicle upon an event may comprise (a) an airbag configured for deployment in standard deployment or in extended deployment; (b) an inflator configured to inflate the airbag for deployment; (c) a retainer SR configured to retain for standard deployment and to release for extended deployment; and (d) a control system configured to actuate the inflator and to operate the retainer SR. The control system may be configured to actuate the retainer SR for extended deployment of the airbag. In standard deployment the airbag may be inflated in a standard form ABT. In extended deployment the airbag may be inflated in an extended form ABX. The extended form ABX may be larger in size than the standard form ABT. In the extended form ABX the airbag may extend further toward the occupant than in the standard form ABT. In the extended form ABX the airbag may deploy further from the inflator toward the occupant than in the standard form ABT. The control system may comprise an electronic control unit. The control system may be configured to actuate the inflator based on a deployment signal indicating the event. The deployment signal may comprise a signal indicating the position of the occupant and/or the seat for the occupant at a distance beyond a threshold distance. If the distance is within the threshold distance the retainer SR may be configured to retain for standard deployment; if the distance is greater than the threshold distance the retainer SR may be configured to release for extended deployment. The retainer may comprise a retaining member SR configured to retain the airbag for standard deployment and to release the airbag for extended deployment. The retaining member SR may comprise a strap. The retaining member SR may comprise a rope. The retaining member SR may comprise a flexible member. The component may comprise a retaining mechanism RT comprising the retainer SR; the retaining member SR may be configured to be retained by the retaining mechanism RT for standard deployment and to be released by the retaining mechanism RT for extended deployment. The retaining mechanism RT may comprise an actuator actuated by the control system. The component may comprise a member WB for the airbag configured to provide for standard deployment and for extended deployment. The member may comprise a tether. The member may comprise a tether comprising a dual web of material. The material may comprise a fabric. The member WB for the airbag may comprise a standard deployment section WBT and an extended deployment section WBX; the member may be configured to be actuated with the retainer SR to retain the airbag for standard deployment with the standard deployment section WBT and to release the airbag for extended deployment with the standard deployment section WBT and the extended deployment section WBX. The member WB for the airbag may comprise a connection section WBC; the retaining member SR may be connected to the connection section WBC of the member WB for the airbag. The standard deployment section WBT of the member may be released for standard deployment. The extended deployment section WBX of the member may be released for extended deployment. The standard deployment section WBT of the member may be released for standard deployment so that the airbag is deployed in standard form ABT. The extended deployment section WBX of the member may be released for extended deployment so that the airbag is deployed in extended form ABX. The retainer SR may be configured to retain the extended deployment section WBX of the member for standard deployment and to release the extended deployment section WBX of the member for extended deployment. The member WB for the airbag may be within the airbag. The member WB for the airbag may be coupled to the retainer SR for standard deployment. The member WB for the airbag may be uncoupled from the retainer SR for extended deployment.

### Exemplary Embodiments—B

According to an exemplary embodiment as shown schematically in the FIGURES, a vehicle interior component may comprise an airbag system providing an airbag module. Sec FIGS. 2A-2B. According to an exemplary embodiment as shown schematically in the FIGURES, the airbag module may comprise a housing, an inflatable airbag cushion and a deployment device that may be controlled by a control unit. The deployment device may comprise an inflator and an actuator. The airbag cushion may comprise a front shell, a rear shell and at least one tether. The airbag cushion may provide two different configurations depending on the position of an occupant. The configurations may be achieved via at least one tether or tether extension along with at least one actuator to control the size of the cushion. The tethers may be fixed to the front or rear shell. A tether extension may be coupled to the tether. The tether extension maybe releasably attached to an actuator. Upon deployment of the airbag cushion, tether length may be controlled by the tether extension and the actuator. If the actuator is not activated, the tether extension may remain attached to the actuator and the cushion may be shallow. If the actuator is activated, the tether extension may be released, the cushion may more deeply expand towards the occupant and the tether and tether extension may be pulled inside the airbag cushion.

According to an exemplary embodiment as indicated in FIGS. 40A-40B, 41A-41B, 42A-42B and 43, a method for use of the airbag system/component may comprise: (a) One or more sensors detect accelerations resulting from decelerations. (b) One or more sensors detect passenger seating position. (c) Transmission of sensed signals to the control unit for diagnosis. (d) Distances of occupants to the airbag module are calculated. (c) Data is compared to vehicle-specific values. If a value above a threshold is detected, the inflator is activated, and the actuator might be activated. (f) The folded airbag cushion is deployed and thus inflated. (g) The tether might be released its full length allowing the airbag cushion to inflate to its maximum size. (h) The method and component may be configured to effectively dissipate relative velocities between the passenger compartment and an occupant during an event. See also FIGS. 8A-8E, 9A-9E, 14A-14C, 15A-15C, 16A-16C, 17A-17C, 18A-18D, 33A and 34A.

REFERENCE SYMBOL LIST

| REFERENCE | |
|---|---|
| SYMBOL | ELEMENT, PART OR COMPONENT |
| V | Vehicle |
| I | Interior |
| C | Component |
| IP | Instrument panel |
| DP | Door panel |
| ST | Seat |
| STK | Seat track |
| SW | Steering wheel/operator control |
| HN | Housing |
| RM | Rim |
| AB | Airbag (front shell and rear shell joined at seam) |
| ABM | Airbag module |
| ABD | Airbag door |
| TX | Cover |
| TR | Seam/tear line (for airbag door) |
| SB | Restraint system/seat belt |
| VP | Occupant (of vehicle) |
| DT | Seat/occupant position/standard deployment |
| DX | Seat/occupant position/extended deployment |
| ABT | Airbag with standard form/deployment |
| ABX | Airbag with extended form/deployment |
| WB | Member/tether/web for airbag |
| WBT | web section for standard form/deployment |
| WBX | web section for extended form/deployment |
| WBC | Web/connector section to connect to retaining |
| | member/retainer |
| RT | Retainer/retaining mechanism |
| RP | Pin for retainer/retaining mechanism |
| SR | Retaining member/strap/rope |
| SRP | Aperture/hole on retaining member/strap/rope |
| NF | Inflator |
| FR | Frame |
| TP | Front/top shell of airbag |
| BP | Back/rear shell of airbag |
| MP | Mounting section/plate (housing) |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for an interior of a vehicle configured for deployment of an airbag for an occupant in a seat of the vehicle upon an event comprising:
(a) an airbag configured to be inflated for deployment;
(b) a retaining mechanism; and
(c) a retaining member configured to be retained by the retaining mechanism for standard deployment of the airbag and to be released by the retaining mechanism for extended deployment of the airbag;
wherein in standard deployment the airbag is inflated in a standard form;
wherein in extended deployment the airbag is inflated in an extended form.

2. The component of claim 1 further comprising a member for the airbag.

3. The component of claim 2 wherein the member comprises a tether coupled to the retaining member.

4. The component of claim 2 wherein the member for the airbag comprises a standard deployment section and an extended deployment section; wherein the retaining member is coupled to the member; so that (1) the extended deployment section is retained by the retaining member and the standard deployment section is deployed for standard deployment and (2) the extended deployment section is released by the retaining member and the standard deployment section and the extended deployment section are deployed for extended deployment.

5. The component of claim 4 wherein the member for the airbag comprises a connection section between the standard deployment section and the extended deployment section; wherein the retaining member is connected to the connection section.

6. The component of claim 1 wherein the retaining member comprises at least one of (a) a strap, (b) a rope, (c) a flexible member and/or (d) a loop.

7. The component of claim 1 wherein the retaining mechanism comprises a pin; wherein the retaining member comprises an aperture configured to be retained by the pin.

8. The component of claim 1 wherein the retaining mechanism comprises an actuator actuated by a control system and a retaining pin configured to be actuated by the actuator.

9. The component of claim 8 wherein the retaining member comprises an aperture configured for engagement with the retaining pin; wherein the aperture is engaged with the retaining pin for standard deployment; wherein the aperture is disengaged from the retaining pin for extended deployment.

10. The component of claim 1 wherein the retaining member comprises a set of retaining members; wherein the extended form comprises a first extended form with one retaining member released and one retaining member retained.

11. The component of claim 10 wherein the first extended form comprises an asymmetrical form.

12. The component of claim 11 wherein the asymmetrical form comprises an inclined surface facing the occupant.

13. The component of claim 1 wherein the retaining member comprises a set of retaining members; wherein the extended form comprises a second extended form with all retaining members released; wherein the second extended form comprises a generally symmetrical form.

14. The component of claim 13 wherein the symmetrical form comprises a parallel surface facing the occupant.

15. The component of claim 1 wherein the retaining member comprises a set of retaining members; wherein one retaining member comprises a first length and one retaining member comprises a second length longer than the first length.

16. The component of claim 15 further comprising a member for the airbag configured to provide for standard deployment of the airbag; wherein the set of retaining members is attached to the member for the airbag so that one retaining member is at a first position along the member and one retaining member is at a second position along the member; wherein the first position is different from the second position.

17. The component of claim 16 wherein the first position and the second position comprise an asymmetrical attachment of the retaining member.

18. A method of operation of an airbag system configured for deployment of an airbag into an interior of a vehicle comprising an occupant in a seat comprising the steps of:
(a) monitoring the operation of the vehicle for an event;
(b) monitoring position of the occupant and/or seat in the interior of the vehicle; and
(c) deploying the airbag upon detection of an event (1) in a standard form if the occupant and/or seat is in a standard position or (2) in an extended form if the occupant and/or seat is beyond the standard position;
wherein the airbag system comprises a member for the airbag coupled to a retaining member for the airbag;
wherein the retaining member is configured to retain the airbag for standard deployment.

19. The method of claim 18 wherein the member for the airbag comprises a standard deployment section and an extended deployment section; wherein the retaining member for the airbag is coupled to the member and to a retaining mechanism; wherein the step of deploying the airbag comprises retaining the retaining member at the retaining mechanism for standard deployment and releasing the retaining member from the retaining mechanism the airbag for extended deployment.

20. The method of claim 19 wherein the step of deploying the airbag in the extended form comprises disconnecting the retaining member intact from the retaining mechanism.
